(19) United States
(12) Patent Application Publication
(10) Pub. No.: US 2009/0200885 A1
(43) Pub. Date: Aug. 13, 2009

(54) Self starting permanent magnet synchronous motor

(75) Inventors: Satoshi Kikuchi, Tokai (JP); Yuuichi Satsuu, Hitachi (JP); Matahiro Komuro, Hitachi (JP); Hiroyuki Mikami, Hitachinaka (JP); Akeshi Takahashi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/318,193

(22) Filed: Dec. 23, 2008

(30) Foreign Application Priority Data
Dec. 25, 2007 (JP) 2007-331314

(51) Int. Cl. H02K 21/46

(52) U.S. Cl. 310/156.78

(57) ABSTRACT

The present invention provides a permanent magnet that a fluorine compound is formed on the surfaces of Fe-based magnetic particles, and a recoil permeability is determined in a range of 1.05 to 1.30 by controlling an iron concentration in the fluorine compound to a range of 1 to 50% to reduce a loss due to magnetization rotation, thereby remedying reduction of a residual magnetic flux density and degradation of steady-state characteristics.

### BACKGROUND OF THE INVENTION

The present invention relates to a rare earth magnet applied to a self-starting permanent magnet synchronous motor.

In recent years, improvement of characteristics of various motors is an essential proposition in view of environmental protection. Therefore, there are many needs for replacing a conventional heavily used induction motor by a magnet motor having a permanent magnet field.

A self-starting permanent magnet synchronous motor can make full-voltage start up by direct feeding of commercial power similar to an induction motor, and in steady operation, it is driven with high efficiency as a magnet motor. Therefore, it is not necessary to add an inverter and the above motor has features that it can be applied relatively easily by replacing the induction motor as energy saving measures for devices heretofore used at a constant-velocity drive.

But, the self-starting permanent magnet synchronous motor has a larger start-up current as it has a larger output, and there is a possibility that the permanent magnet is demagnetized by an excessive demagnetized magnetomotive force. As a countermeasure, it is effective to adopt a permanent magnet having high demagnetization resistance. But, the permanent magnet having the improved demagnetization resistance has a disadvantage that its basic performance lowers because a residual magnetic flux density tends to become low.

Recently, developments have been made for improvement of the above-described magnet magnetic properties for a permanent magnet, especially a rare earth magnet, and one means therefor is disclosed in the following JP-A-2006-066853.

JP-A-2006-066853 discloses that a layer-like grain boundary phase containing a fluorine compound is formed on the grain boundary of the rare earth magnet represented by Nd—Fe—B to realize the rare earth magnet that both a high magnetic coercive force and a high residual magnetic flux density can be established. And, it also considers a thickness and a coverage factor of a layer-like fluorine compound.

### SUMMARY OF THE INVENTION

JP-A-2006-066853 realizes the improvement of magnet performance by forming the layer-like fluorine compound on the magnet grain boundary. But, magnetic coercivity, residual magnetic flux density, squareness of a demagnetization curve, thermal demagnetizing properties, magnetizability, anisotropy, corrosion resistance and the like are not necessarily sufficient, and there are still various problems remaining to be solved for application to a self-starting permanent magnet synchronous motor.

The present invention realizes a magnet having such magnetic properties further improved and provides a self-starting permanent magnet synchronous motor having good motor characteristics such as demagnetization resistance.

The present invention has been made in view of the above circumstances and has, as a permanent magnet structure to be applied to the self-starting permanent magnet synchronous motor, particles made of ferromagnetic material mainly made of iron and a fluorine compound layer formed of fluorine compound particles of one or more of an alkali element, an alkaline earth element and a rare earth element. The fluorine compound layer is formed in a layer shape on the surfaces of particles made of the ferromagnetic material, and the fluorine compound particles form a magnet structure having an iron concentration of 1 atom % to 50 atom %.

The iron configures the magnet contained in the fluorine compound particles without changing the crystal structure of the fluorine compound.

The particles made of the ferromagnetic material configure a magnet which is magnetic particles comprised of R—Fe—B (R denotes a rare earth element).

The fluorine compound particles configure a magnet which is mainly composed of any of NdF₃, LiF, MgF₂, CaF₂, ScF₃, VF₂, VF₃, CrF₂, CrF₃, MnF₂, MnF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂ and BiF₃.

And, the fluorine compound particles have an average particle diameter of 1 nm to 500 nm, and the fluorine compound layer configures a magnet having higher resistance than the particles made of the ferromagnetic material.

A magnet is configured to have a recoil permeability of more than 1.04 and less than 1.30 and a specific resistance of 0.2 mΩcm or more.

A magnet is configured to have the fluorine compound layer formed with a coverage factor of 50% to 100% on the surfaces of particles made of the ferromagnetic material.

A magnet is configured that the fluorine compound particles make grain growth with hot forming of particles made of the ferromagnetic material.

A magnet is configured that the fluorine compound particles make grain growth with an average crystal grain size in a range of 1 nm to 500 nm.

The fluorine compound particles can also be hydrofluoric acid compound particles.

Means of the present invention will be described below specifically.

The present invention has features that a plate-like or layer-like fluorine compound is formed at a grain boundary to increase the interface between the fluorine compound and the main phase, the thickness of the fluorine compound is decreased, or the fluorine compound is turned into a ferromagnetic phase.

A surface treatment can be used as a method of forming the fluorine compound into a layer. The surface treatment is a technique to coat a fluorine compound containing at least one of alkali metal element, alkaline earth element or rare earth element or a fluorine-oxygen compound partially containing oxygen on magnetic particle surfaces.

A gel-like fluorine compound is pulverized in an alcohol solvent, coated onto the magnetic particle surfaces and heated to remove the solvent. The solvent is removed by a heat treatment at 200 degrees C. to 400 degrees C., and a heat treatment at 500 degrees C. to 800 degrees C. causes to diffuse oxygen, a rare earth element and a fluorine compound composing element between the fluorine compound and the magnetic particles.

The magnetic particles contain 10 to 5000 ppm of oxygen and light elements such as H, C, P, Si and Al as other impurity elements. The oxygen contained in the magnetic particles is present not only as a rare earth oxide or an oxide of light elements such as Si and Al, but also as a phase containing oxygen of a composition displaced from a stoichiometric composition in a mother phase or a grain boundary.

Such an oxygen-containing phase decreases magnetization of the magnetic particles and also affects the shape of a magnetization curve. Namely, a residual magnetic flux density has a lowered value, an anisotropy field reduces, the squareness of a demagnetization curve lowers, the magnetic coercive force decreases, an irreversible demagnetizing factor increases, thermal demagnetization increases, magnetization characteristic changes, corrosion resistance degrades, mechanical property degrades, and the reliability of the magnet lowers. Thus, since oxygen affects so many characteristics, there has been devised a process that oxygen is not remained in the magnetic particles.

When the fluorine compound is formed on the magnetic particles containing iron and heated at a temperature of 400 degrees C. or more, diffusion of iron into the fluorine compound layer is caused. The iron in the magnetic particles is contained as an intermetallic compound containing a rare earth element, but iron atoms are diffused into the fluorine compound by heating.

To form the rare earth-fluorine compound on the magnetic particle surfaces, REF₃ is grown by a heat treatment at 400 degrees C. or below, and heated and held under a degree of vacuum of 1×10⁻⁴ Torr or below at 500 to 800 degrees C. The holding time is 30 minutes. This heat treatment diffuses the iron atoms of the magnetic particles into the fluorine compound, and the rare earth elements in the magnetic particles are also diffused. Thus, they are observed in REF₃, REF₂ or RE(OF) or in the vicinity of their grain boundaries.

The fluorine compound and the fluorine-oxygen compound have a crystal structure which is a face-centered cubic lattice structure, and its lattice constant is 0.54 to 0.60 nm. An iron content to the fluorine compound and the oxygen-fluorine compound is limited so as to provide remarkable effects of increasing a residual magnetic flux density, increasing a magnetic coercive force and improving squareness of a demagnetization curve, thermal demagnetizing properties, magnetizability, anisotropy, and corrosion resistance.

To have a density of 90% or more at the time of hot forming, it is necessary to have a temperature at which the mother phase is softened, and the forming temperature becomes 500 to 800 degrees C. The forming at the above-temperature range grows the crystal grains of the fluorine compound layer, and the diffusion proceeds between the magnetic particles and the fluorine compound.

If the temperature exceeds 800 degrees C., a soft magnetic component such as αFe starts to grow. Therefore, it is desirable to press at a forming temperature of less than 800 degrees C. If formation of the soft magnetic component can be suppressed by various added elements, the pressure temperature may exceed 800 degrees C. When the magnetic particles are based on NdFeB, Nd, Fe, B or added elements are enhanced by a stress among the particles generated by a heating temperature of 500 degrees C. or more and a forming pressure and diffused into the fluorine compound where the particles grow.

At the above temperature, the iron concentration in the fluorine compound layer is variable depending on the positions, but a portion (such as a grain boundary portion or a defect portion) of 1 atom % appears. The driving force for diffusion includes a temperature, a stress (distortion), a concentration difference, a defect and the like, and the diffused results can be confirmed through an electron microscope.

Elements such as Nd and B in the fluorine compound are not elements which largely change the magnetic properties of the fluorine compound, but the iron atom changes the magnetic properties of the fluorine compound depending on its concentration. Therefore, the magnetic properties as the magnet can be set to a prescribed value by limiting its concentration.

When it is assumed that a total value of elements other than B is 100 atom % and the iron concentration is 50 atom % or below, the fluorine compound structure can be held, but when the iron concentration exceeds 50 atom %, an amorphous phase or a phase having iron as a mother body appears, and a phase having a small magnetic coercive force is mixed. Therefore, the iron concentration must be set to 50 atom % or below.

The above NdFeB-based magnetic particles include magnetic particles including the same phase as the crystal structure of Nd₂Fe₁₄B in the main phase, and the transition metals such as Al, Co, Cu and Ti may be contained in the above main phase. And, a part of the B may be C. And, an oxide or a compound such as Fe₃B or Nd₂Fe₂₃B₃ may be contained other than the main phase. When the fluorine compound layer is formed on the Sm₂Co₁₇-based magnetic particles and superheat forming is performed, Co is diffused into the fluorine compound layer. When Co to be diffused is increased, Co in the fluorine compound becomes soft magnetic, so that a loss increases. For loss reduction, the Co concentration in the fluorine compound layer may be determined to be 50 atom % or below of Co.

Since the fluorine compound layer shows higher resistance than NdFeB-based magnetic particles at a temperature of 800 degrees C. or below, the resistance of the NdFeB sintered magnet can be increased by forming the fluorine compound layer, and as a result, an eddy current loss can be reduced.

The fluorine compound layer may contain as an impurity an element, if it does not exhibit a ferromagnetic property at around room temperature at which an effect on the magnetic properties is small, other than the fluorine compound. Fine particles of a nitrogen compound or carbide may be mixed into the fluorine compound to provide high resistance.

The molded product, which satisfies high specific resistance, high magnetic coercive force and a high magnetic flux density, can be provided by forming a film containing fluorine on iron-based magnetic particles, conducting a heat treatment and molding as described above. And, the application of the molded product to a self-starting permanent magnet synchronous motor provides the self-starting permanent magnet synchronous motor having good motor characteristics such as a low iron loss, a high induced voltage and the like with the demagnetization resistance substantially improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a radial cross-sectional view of self-starting permanent magnet synchronous motor according to an example of the present invention.

FIG. 2 is a radial cross-sectional view of a rotor of the self-starting permanent magnet synchronous motor according to the example of the present invention.

FIG. 3 is a graph showing measured data of motor efficiency and an induced electromotive force waveform distortion.

FIG. 4 is a relationship between recoil permeability and losses

FIGS. 5A to 5E show EDX analysis profiles

FIGS. 6A to 6C show EDX analysis profiles.

FIG. 7 is a transmission electron micrograph.

FIG. 8 is a transmission electron micrograph.

FIG. 9 is a transmission electron micrograph.

FIGS. 10A to 10E show a magnetic film process diagram.

FIG. 11 is a radial cross-sectional view of a self-starting permanent magnet synchronous motor according to another example of the present invention.

FIG. 12 is a radial cross-sectional view of a self-starting permanent magnet synchronous motor according to another example of the present invention.

FIG. 13 is a radial cross-sectional view of a self-starting permanent magnet synchronous motor according to another example of the present invention.

FIG. 14 is a radial cross-sectional view of a self-starting permanent magnet synchronous motor according to another example of the present invention.

FIG. 15 is a radial cross-sectional view of a self-starting permanent magnet synchronous motor according to another example of the present invention.

### DESCRIPTION OF THE EMBODIMENTS

Modes of conducting the present invention will be described below with reference to the drawings.

### Example 1

### Explanation of Self-Starting Permanent Magnet Synchronous Motor

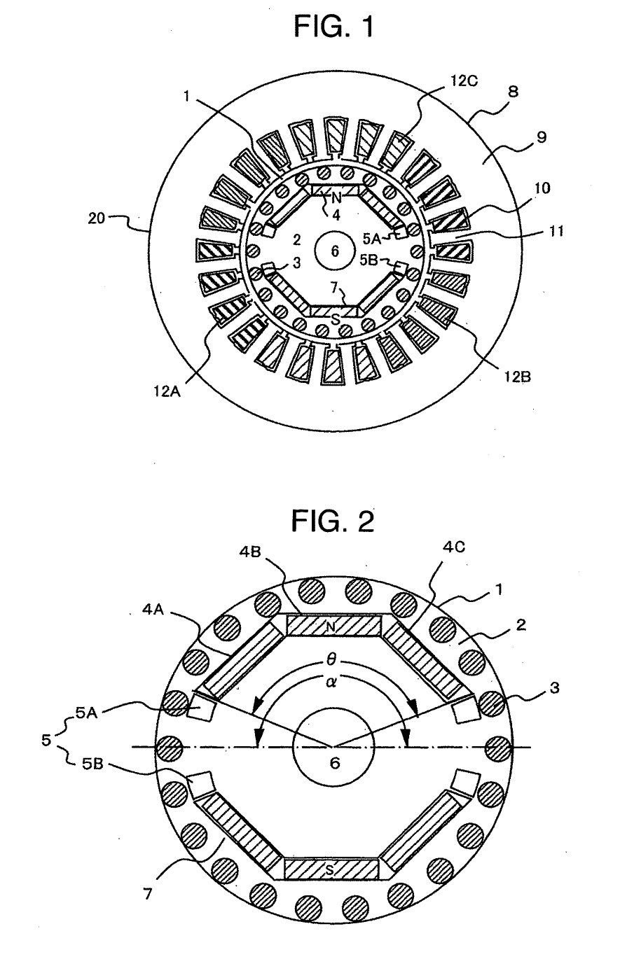

FIG. 1 shows a radial cross-sectional view showing an example of a permanent magnet type synchronous motor according to the present invention.

In FIG. 1, a self-starting permanent magnet synchronous motor 20 comprises a stator 8 and a rotor 1.

The stator 8 has a stator iron core 9, plural (24 in the drawing) slots 10 formed therein, and teeth 11 divided by the slots 10. Armature windings 12 comprising U-phase windings 12A, V-phase windings 12B and W-phase windings 12C are wound by distributed winding with the same phase distributed in the plural slots 10.

By configuring as described above, when the armature windings 12 are supplied with a fixed frequency AC voltage, the rotor 1 can be activated and accelerated as an induction motor, and then it becomes possible to perform a constant-velocity drive as a synchronous motor.

FIG. 2 is a radial cross-sectional view of a rotor of a synchronous motor according to an example of the present invention.

In FIG. 2, the rotor 1 is configured by arranging within a rotor iron core 2 provided on a shaft 6 plural starting cage type windings 3 and plural (three per magnetic pole in the drawing) permanent magnets 4, which are mainly composed of rare earth and embedded into a magnet insert hole 7, such that the number of magnetic poles becomes two. And, holes 5 (5A, 5B) are formed between the magnetic poles to prevent a leakage magnetic flux from occurring between the magnetic poles.

In order to improve the magnetic properties, the permanent magnets 4 have the surfaces subjected to a fluorine compound treatment, 1 to 100 nm fluorine compound particles are grown on the permanent magnet surfaces, and a magnetic coercive force is improved by a heat treatment at 400 to 800 degrees C. The permanent magnet may be either a thick film or a sintered magnet. The above heat treatment may be performed to heat by millimeter-wave irradiation. The details will be described later.

The permanent magnets 4 have a substantially trapezoidal cross sectional shape but may be configured to have a substantially rectangular cross sectional shape. Besides, they may be configured by laminating plural thin flat shape magnets.

The permanent magnets 4 are embedded with a ratio between a width opening θ and a magnetic pole pitch angle α in a range of 0.54<θ/α<0.91 or below.

A width opening of the permanent magnet 4 and circumferential pitch angle of magnetic flux distribution of the permanent magnet 4 may be different depending on its magnetization method. In this example, it is assumed that the circumferential pitch angle of magnetic flux distribution of the permanent magnet 4 is equal to the width opening of the permanent magnet 4.

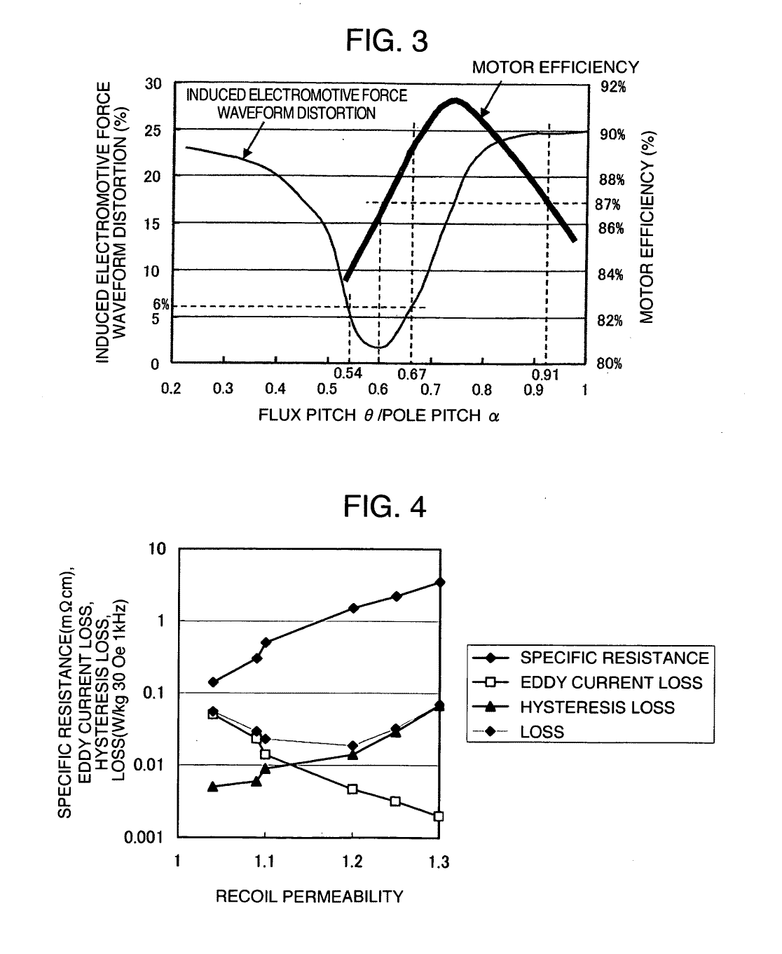

FIG. 3 is a graph showing measured data of an induced electromotive force waveform distortion and the motor efficiency. The horizontal axis represents a ratio θ/α between a flux pitch angle θ and a magnetic pole pitch angle α, and the vertical axis indicates an induced electromotive force waveform distortion (%), and motor efficiency (%).

According to Japanese Industrial Standards JIS-C4212, the efficiency of the high efficiency low-pressure three-phase squirrel-cage induction motor is required to satisfy 87.0% or more under a condition of a coolant temperature of 40 degrees C. or below in a case of operating, for example, a motor of a totally-enclosed type, 3.7-kW output, two poles, 200 V and 50 Hz. It can be said from the above that if the efficiency of a permanent magnet type synchronous motor is 87% or more, it is a good characteristic in comparison with the induction motor of a similar size in the case where it is driven in a compressor which has an environment of the coolant temperature of 100 degrees C. or more.

It is seen from FIG. 3 that when a ratio θ/α between a width opening θ and a magnetic pole pitch α is 0.62 to 0.91, an efficiency of 87% or more can be secured, when the ratio θ/α is in a range of exceeding 0.67, there is a peak, and when the ratio θ/α is 0.72, the best feature is provided. Thus, the motor characteristic is desired that the ratio θ/α is set to a range of 0.67 to 0.91.

It is because when the permanent magnet has an excessively large circumferential pitch angle θ, the flux of the permanent magnet increases, and the iron loss generated in the stator increases. And, the induced electromotive force to the applied voltage increases to be a field-weakening drive, so that the input current increases. Meanwhile, when the circumferential pitch angle θ of the permanent magnet is extremely decreased, the magnetic flux amount of the permanent magnet decreases, the induced electromotive force to the applied voltage becomes minimum to provide a magnetizing action, and the input current increases too.

Meanwhile, it is seen from the same graph that when the ratio θ/α is in a range of 0.54 to 0.67, the distortion of induced electromotive force waveform can be minimized. Although it is not an effective dimension in view of the motor efficiency, it has a sufficient value in terms of the motor vibration and noise. Based on the result, the circumferential pitch angle of the permanent magnet 4 or the circumferential pitch angle θ of the magnetic flux distribution produced by the permanent magnet 4 was configured to have a magnetic pole pitch angle α of 0.54 to 0.91.

### <Explanation of Permanent Magnet 4>

As an NdFeB-based powder, quenched powder mainly containing Nd₂Fe₁₄B is prepared, and a fluorine compound is formed on the quenched powder surface. To form NdF₃ on the quenched powder surface, Nd(CH₃COO)₃ is dissolved with H₂O as a raw material, and HF is added.

The addition of the HF forms gelatinous NdF₃.XH₂O, which is then subjected to centrifugal separation to remove the solvent, and mixed with the NdFeB powder and coated. The solvent is evaporated from the mixture, and hydrated water is evaporated by heating. The obtained film was examined by an XRD.

The film is formed along the uneven surface of the NdFeB powder. As a result, it was found that the fluorine compound film is formed of NdF₃, NdF₂, NdOF or the like. The powder having a particle diameter of 1 to 300 μm is heated while preventing it from being oxidized at a temperature of less than 800 degrees C. which is a heat treatment temperature at which the magnetic properties lower to obtain magnetic particles which have a high-resistance layer formed on the surface and have a residual magnetic flux density of 0.7 T or more. When the particle diameter is less than 1 μm, oxidation occurs easily, and the magnetic properties are deteriorated easily. When the particle diameter is larger than 300 μm, the provision of high resistance or another effect that is a magnetic property improving effect by formation of the fluorine compound lowers.

For the magnetic properties, the magnetic particles are put into a metal mold, temporarily molded under a compressive load of 2 t/cm², and press formed in a larger metal mold at a temperature of 500 degrees C. to 800 degrees C. without exposing to the atmosphere. At this time, the fluorine compound and the mother phase, which is magnetic particles mainly composed of Nd₂Fe₁₄B, in the metal mold are deformed by a load of 1 t/cm² or more, and magnetic anisotropy is expressed. As a result, the molded product has a residual magnetic flux density of 1.0 T to 1.4 T, and a high-resistance magnet having specific resistance of 0.2 to 2 mΩcm is obtained.

The squareness of a demagnetization curve of the molded product depends on molding conditions and fluorine compound forming conditions. It is because the direction of a c axis which is a crystal axis of the mother phase Nd₂Fe₁₄B is variable depending on the molding conditions and fluorine compound forming conditions. It was found by structure analysis and composition analysis through a transmission electron microscope that the inclination of the demagnetization curve of the molded product near a zero magnetic field depends on a dispersion degree in the direction of the c axis and the structure and composition around the interface between the fluorine compound and the magnetic particles.

In a molded product having a density of 90 to 99%, the above-described fluorine compound layer is united, diffused and has grain growth during molding, and partly sintered with the fluorine compound layer on the magnetic particle surfaces served as a binder within the molded product. When the fluorine compound film has a thickness of about 500 nm, the fluorine compound has a particle diameter of 1 to 100 nm immediately after the fluorine compound is formed on the magnetic particles, but the fluorine compound has a particle diameter of 10 to 500 nm within the molded product, and the fluorine compound layer formed on a different magnetic particle surfaces is bonded. Thus, there were observed many portions in which the crystal grains had grown and sintered.

It was found that there was iron within the fluorine compound crystal in which crystal grains had grown. Since the iron is not present in the fluorine compound before the crystal grains are grown, it is presumed that the iron was diffused from the magnetic particles at the time of the growth of the crystal grains. It is possible to presume that when the iron was diffused, the rare earth element and also oxygen, which was originally on the magnetic particle surfaces, were also diffused.

The fluorine compound in which the iron has diffused has NdF₂ larger than NdF₃. The concentration of iron in the fluorine compound determined by EDX analysis is 1% to 50% in average. The composition with the concentration of around 50% was amorphous. Since oxygen is also contained, it was found that the molded product has NdF₂, NdF₃, Nd(O, F) and NdFeFO amorphous other than NdFeB magnetic particles mainly having Nd₂Fe₁₄B mother phase, and the fluorine compound and the fluorine-oxygen compound contain therein an average iron concentration of 1% to 50%. It is not known accurately in which site the iron atom is arranged within the fluorine compound or the fluorine-oxygen compound, but it is presumed that the iron atom is relocated to the position of the fluorine or rare earth atom.

Both the above-described high residual magnetic flux density and high resistance can be achieved by forming a fluorine compound layer on R—Fe—X (R denotes a rare earth element, X denotes a third element) or a R-T compound (R denotes a rare earth element, T denotes Fe, Co or Ni), growing the crystal grains in the fluorine compound layer to perform a diffusion reaction with the mother phase, and determining that the fluorine compound layer becomes a sintering binder.

Such a fluorine compound is RFn (n denotes 1 to 3) comprised of fluorine and element R configured of one element or more selected from a rare earth element or Li, Mg, Ca, 3d transition elements and contains 1 to 50% of iron of magnetic particles by hot forming. When the iron concentration in the fluorine compound becomes higher than 50% and in a range of 50 to 80%, the fluorine compound layer becomes amorphous partly, and there is a possibility of deteriorating the magnetic properties. Therefore, it is necessary to select hot molding conditions and fluorine compound forming conditions to have the iron concentration of 50% or below.

The fluorine compound can be formed by a surface treatment using a solution containing oxygen or carbon in LiF, MgF₂, CaF₂, scF₃, VF₂, VF₃, CrF₂, CrF₃, MnF₂, MnF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂, BiF₃ or their fluorine compound other than NdF₃. In the fluorine compound or the fluorine-oxygen compound, the iron concentration is determined to be 1 to 50%, so that the recoil permeability can be set to a range of 1.05 to less than 1.30, and a magnet loss can be reduced.

### Example 2

A DyF₃ or TbF₃ layer is formed on Nd₂Fe₁₄B magnetic particles having a high residual magnetic flux density to which a high magnetic coercivity provision element such as Dy, Tb, Pr or the like is not added. Thus, a high residual magnetic flux density and a high magnetic coercive force can be achieved. A cast ingot is produced by dissolving an alloy having a composition similar to Nd₂Fe₁₄B according to a high frequency dissolving method. The ingot is formed into 1 to 10 μm powder by a pulverizer. To form a fluorine compound layer on the powder surface, gelatinous DyF₃.XH₂O or TbF₃.XH₂O is subjected to centrifugal separation. A solvent removed processing liquid is mixed with the NdFeB powder, the solvent is evaporated from the mixture, and hydrated water is evaporated by heating.

The powder is subjected to horizontal magnetic field pressing or vertical magnetic field pressing to orient the magnetic particles in a magnetic field of 0.5 T to 1 T, sintered in inert gas or in vacuum at 900 to 1100 degrees C. for four hours, and heated at 600 degrees C. to obtain a sintered body having a density of 90 to 99%.

When a Dy fluorine compound is formed, the fluorine compound layer is formed of DyF₂, DyF₃, Dy(O, F) or the like in the sintered body, and diffusion of Fe or Nd in the fluorine compound or the fluorine-oxygen compound by sintering is recognized. When Fe increases in the fluorine compound layer, it becomes difficult to provide high magnetic coercivity, so that Fe must be suppressed to 50% or below.

The above Dy and Tb are segregated around the grain boundary after the sintering, and both a high residual magnetic flux density and a high magnetic coercive force can be realized. Thus, the fluorine compound is formed by the surface treatment, and a rare earth rich phase which contributes to provision of high magnetic coercivity is artificially formed on the surfaces of magnetic particles. Thus, a sintered magnet with fine squareness having a residual magnetic flux density of 1.3 to 1.6 T and a magnetic coercive force of 20 to 35 kOe can be obtained.

When the quenched magnetic particles undergone the surface treatment with the fluorine compound prior to the insertion into the press machine is undergone a heat treatment at 500 degrees C. to 800 degrees C., the following improvement of characteristics can be confirmed. Specifically, when the heat treatment is performed, a portion containing 1 atom % of iron is formed on the fluorine compound layer, and diffusion is also observed between rare earth atoms. By the heat treatment at a temperature higher than 800 degrees C., growth of a soft magnetic phase such as αFe is observed, and the magnet characteristics are deteriorated. Characteristic improvement by a heat treatment at 500 to 800 degrees C. include the magnetic coercive force improvement, squareness improvement, temperature improvement, provision of high resistance and the like, and a bonded magnet mixed with an organic binder can be formed.

### Example 3

Quenched powder mainly composed of Nd₂(Fe, Co)₁₄B is produced as NdFeB-based powder, and a fluorine compound is formed on the surface of the obtained powder. The quenched powder may contain amorphous. To form DyF₃ on the quenched powder surface, Dy(CH₃COO)₃ is dissolved as a raw material in H₂O, and HF is added. The addition of HF produces gelatinous DyF₃.XH₂O. It is subjected to centrifugal separation to remove the solvent, and it is mixed with the NdFeB powder. The solvent is evaporated from the mixture, and hydrated water is evaporated by heating. The formed fluorine compound layer having a film thickness of 1 to 1000 nm was examined by XRD. As a result, it was found that the fluorine compound film was comprised of DyF₃, DyF₂, DyOF or the like.

The magnetic powder having a particle diameter of 1 to 300 μm is heated while preventing it from being oxidized at a temperature of less than 800 degrees C. which is a heat treatment temperature at which the magnetic properties lower to obtain magnetic particles which have a high-resistance layer formed on the surfaces and have a residual magnetic flux density of 0.7 T or more. At this time, by a heat treatment at 350 to 750 degrees C., the improvement of the magnetic coercive force and the improvement of squareness of the magnetic particles can be confirmed. When the particle diameter is less than 1 μm, oxidation occurs easily, and the magnetic properties are deteriorated easily. When the particle diameter is larger than 300 μm, the provision of high resistance or another effect that is a magnetic property improving effect by formation of the fluorine compound lowers.

For the magnetic properties, the magnetic particles are placed into a metal mold, temporarily molded under a compressive load of 1 t/cm², and press formed in a larger metal mold at a temperature of 400 degrees C. to 800 degrees C. without exposing to the atmosphere. At this time, magnetic particles mainly composed of the fluorine compound and the mother phase Nd₂Fe₁₄B in the metal mold are deformed by a load of 1 t/cm² or more, and magnetic anisotropy is expressed. As a result, the molded product has a residual magnetic flux density of 1.0 T to 1.4 T, and a high-resistance magnet having specific resistance of 0.2 to 2 mΩcm is obtained.

The squareness of a demagnetization curve of the molded product depends on molding conditions, fluorine compound forming conditions. This is because the direction of the c axis which is a crystal axis of the mother phase Nd₂Fe₁₄B is variable depending on the molding conditions and fluorine compound forming conditions. It was found by structure analysis and composition analysis through a transmission electron microscope that the inclination of the demagnetization curve of the molded product near a zero magnetic field depends on a dispersion degree in the direction of the c axis and the structure and composition around the interface between the fluorine compound and the magnetic particles.

In a molded product having a density of 90 to 99%, the above-described fluorine compound layer is united and diffused, and has grain growth during molding, and partly sintered with the fluorine compound layer on the magnetic particle surfaces served as a binder within the molded product. When the fluorine compound film has a thickness of about 500 nm, the fluorine compound has a particle diameter of 1 to 100 nm immediately after the fluorine compound is formed on the magnetic particles, but the fluorine compound has a particle diameter of 10 to 500 nm within the molded product, the fluorine compound layer formed on a different magnetic particle surfaces is bonded, and there are observed many portions in which the crystal grains have grown and sintered.

It was found that the fluorine compound crystal in which crystal grains have grown contains iron, cobalt and Nd therein. Since the iron is not present in the fluorine compound before the crystal grains are grown, it is considered that the iron was diffused from the magnetic particles at the time of growth of the crystal grains. It is possible to presume that when the iron was diffused, the rare earth element and also oxygen, which was originally on the magnetic particle surfaces, were also diffused.

The fluorine compound in which the iron has diffused has DyF₂ larger than DyF₃. The concentration of iron in the fluorine compound determined by EDX analysis is 1% to 50% in average. The composition with the concentration of around 50% was amorphous. Since oxygen is also contained, it was found that the molded product had (Dy, Nd)F₂, NdF₃, Nd(O, F) and DyFeFO amorphous other than NdFeB magnetic particles mainly having Nd₂Fe₁₄B mother phase, and the fluorine compound and the fluorine-oxygen compound contain therein an average iron concentration of 1% to 50%.

For the NdFeB magnetic particles, magnetic particles having a diameter of 1 to 20 μm to be used for a sintered magnet may be used. It is not known accurately in which site the iron atom is arranged within the fluorine compound or fluorine-oxygen compound, but it is presumed that the iron atom is relocated to the position of the fluorine or rare earth atom.

Both the above-described high residual magnetic flux density and provision of high resistance can be achieved by forming a fluorine compound layer on R—Fe—X (R denotes a rare earth element, X denotes a third element) or R-T compound (R denotes a rare earth element, T denotes Fe, Co or Ni), so that the crystal grains in the fluorine compound layer grow to perform a diffusion reaction with the mother phase, and the fluorine compound layer becomes a sintering binder.

The fluorine compound can be used as a binder for Fe-based soft magnetic material such as amorphous, a silicon steel plate or an electromagnetic stainless steel other than the NdFeB-based and SmCo-based magnets, and the fluorine compound generates heat selectively by irradiation of millimeter wave or microwave, and the material can be bonded.

### Example 4

Quenched powder mainly composed of Nd₂(Fe, Co)₁₄B is produced as NdFeB-based powder, and a fluorine compound is formed on the powder surface. The quenched powder is flaky powder having a thickness of 15 to 50 μm and may contain amorphous. To form NdF₃ on the quenched powder surface, Nd(CH₃COO)₃ is dissolved as a raw material in H₂O, and HF is added. The addition of HF produces gelatinous NdF₃.XH₂O. It is subjected to centrifugal separation to remove the solvent, and it is mixed with the NdFeB powder. The solvent is evaporated from the mixture, and hydrated water is evaporated by heating.

The formed fluorine compound layer having a film thickness of 1 to 1000 nm was examined by XRD. It was found that the fluorine compound layer is formed along the shape of the powder surface, and in the coated state, a precursor of the fluorine compound is partly observed, and the particle diameter becomes 1 to 100 nm after the solvent is evaporated. It was found that the fluorine compound film is comprised of NdF₃, NdF₂, NdOF and the like.

Magnetic powder having a particle diameter of 1 to 300 μm is heated while preventing it from being oxidized at a temperature of less than 800 degrees C. which is a heat treatment temperature at which the magnetic properties lowers to obtain magnetic particles which have a high-resistance layer formed on the surface and have a residual magnetic flux density of 0.7 T or more. At this time, by a heat treatment at 350 to 750 degrees C., the improvement of the magnetic coercive force and the improvement of squareness of the magnetic particles can be confirmed. When the particle diameter is less than 1 μm, oxidation occurs easily, and the magnetic properties is deteriorated easily. When the particle diameter is larger than 300 μm, the provision of high resistance or another effect that is a magnetic property improving effect by formation of the fluorine compound lowers.

For molding, the magnetic particles are placed into a metal mold and press formed in the metal mold at a temperature of 400 degrees C. to 800 degrees C. under a compressive load of 1 t/cm². As a result, the molded product has a residual magnetic flux density of 0.7 to 0.9 T, and a high-resistance magnet having specific resistance of 0.2 to 2 mΩcm is obtained. The molded product has a density which is variable depending on the hot forming temperature, and it is desirable to mold at 500 to 800 degrees C. in order to obtain a density of 90% or more. A high density can be obtained by molding at a high temperature, but it is desirable to mold at a low temperature to obtain a high density because another element tends to diffuse into the fluorine compound layer.

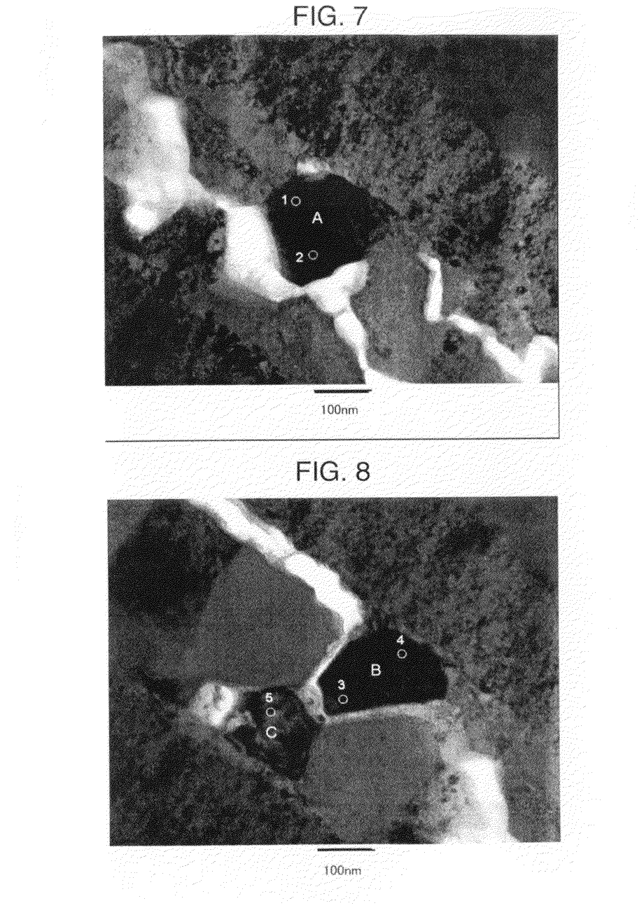

FIG. 7 shows a transmission electron micrograph of a cross section of a sample formed using magnetic particles coated with an NdF₃ layer of 100 nm. In FIG. 7, an area surrounded by a dotted line is the NdF₃ layer, and an area A surrounded by a solid line is NdF₃ particles.

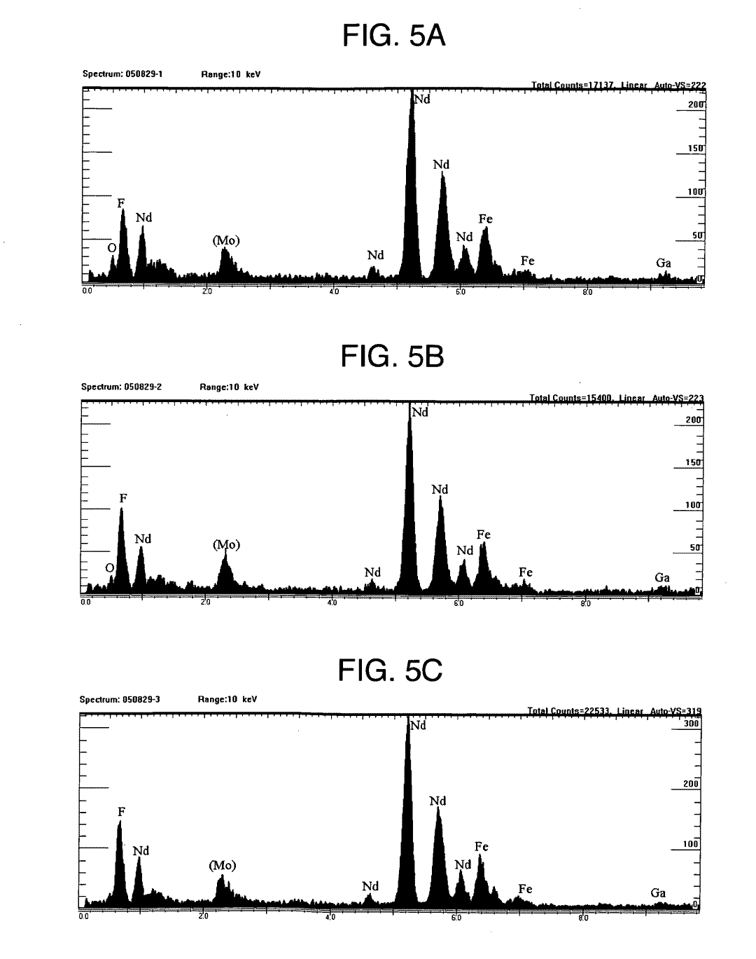

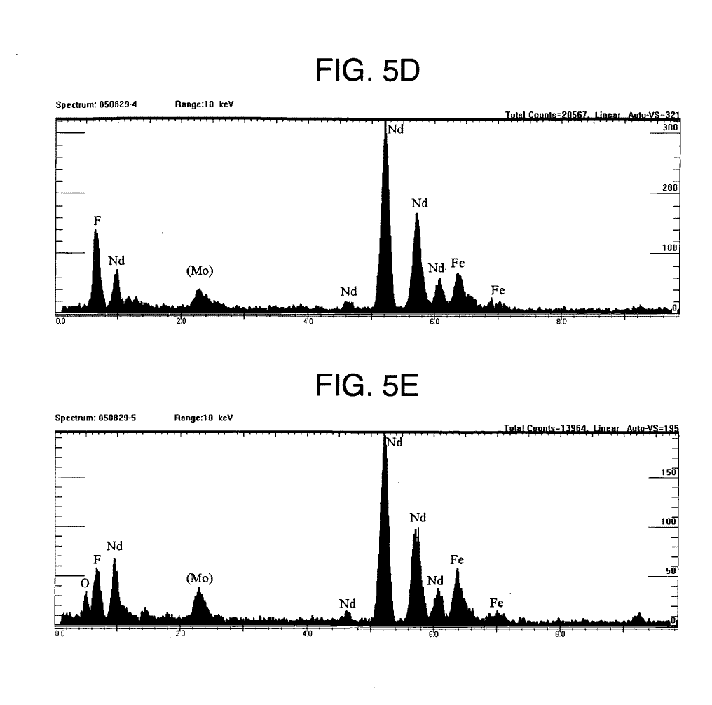

In the texture after NdF₃ coating before hot forming, a particle diameter of NdF₃ particles in the NdF₃ layer was 1 to 20 nm. The NdF₃ particles are grown by hot forming and have a particle diameter of 100 nm or more as shown in FIG. 7. EDX analysis profiles obtained by measuring the NdF₃ particles in the region A are shown in FIGS. 5A, 5B. FIG. 5A shows a result of measuring at 1 in the region A, and FIG. 5B shows a result of measuring at 2 in the region A.

The profiles show Nd, Fe, F, O, Mo and Ga. The Mo is a mesh material on which a TEM sample is placed and not a signal from the molded product. The Ga is ion irradiated at the time of decreasing the thickness for the TEM observation. Since no Fe was observed in the profile of the NdF₃ or NdF₂ layer immediately after coating, it is presumed that the Fe was diffused into the fluorine compound by hot forming. The Fe was seen even when regions other than A were observed, and it was 1 atom % (Fe in the total excluding B) or more.

FIG. 8 is a transmission electron micrograph of a cross section of a sample formed at a temperature higher than in FIG. 7. In FIG. 8, an Nd fluorine compound having crystal grains (about 200 nm) larger than in FIG. 7 was seen. EDX profiles obtained by measuring the particles in regions B and C are shown in FIGS. 5C, 5D, 5E. FIGS. 5C, 5D correspond to 3 and 4 in the region B, and FIG. 5E corresponds to 5 in the region C. It is seen that the profiles of FIGS. 5C to 5E also show Fe, indicating the presence of 1% or more of Fe. Since these crystal grains are of NdF₂, it is presumed that Fe atom is relocated in a crystal lattice of NdF₂

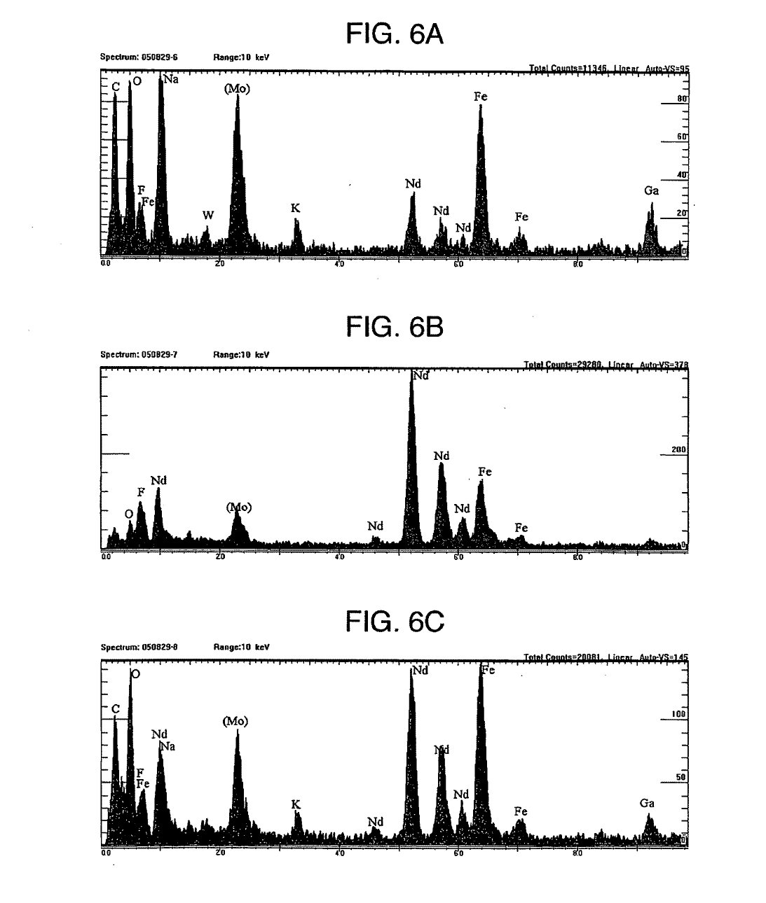

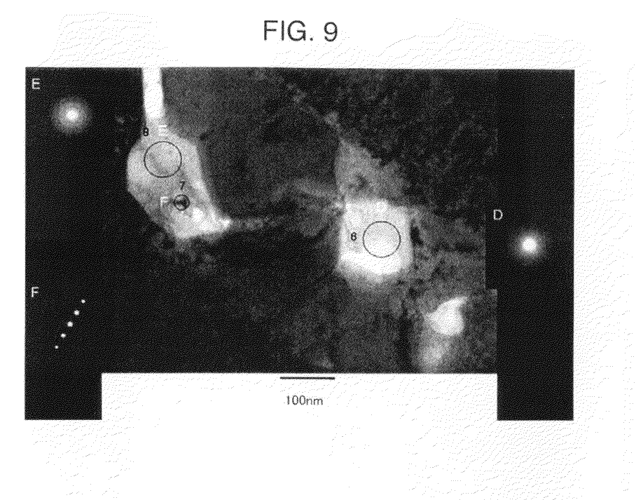

FIG. 9 is a transmission electron micrograph of a cross section of a sample when formed at a high temperature. In FIG. 9, the crystal grain boundary becomes blur, and a sample having an average particle diameter of 500 nm is obtained. EDX analysis profiles obtained by measuring at 6, 7, 8 in regions of NdF₃ particles in FIG. 9 are shown in FIGS. 6A, 6B, 6C. The correspondence relation between FIG. 9 and FIG. 6 is similar to that described above. It is seen that the Fe atom concentration has Fe peak which is higher than Nd peak in a range of 4.0 to 8.0 keV in correspondence with FIGS. 6A, 6C. Meanwhile, portion F is NdF₂ according to a diffraction image, and Fe of this portion is smaller in concentration than in the amorphous portion. At D and E, the Fe concentration exceeds 50%, and at F, it is less than 50%.

Accordingly, the growth of a layer of 50% or more of Fe having a structure similar to amorphous can be suppressed by controlling the Fe concentration in the fluorine compound or the fluorine compound layer. Heating and pressing conditions for the above object include cold pressing, short time molding or low oxygen molding. The Fe concentration in the fluorine compound layer is set to 50% or below, so that it is possible to reduce the shape of the demagnetization curve to a small shape having recoil permeability of 1.04 to 1.30.

### Example 5

As an NdFeB-based powder, the hydrogen-treated powder mainly comprised of Nd₂Fe₁₄B is prepared, and the fluorine compound is formed on the surface of the hydrogen-treated powder.

NdF₃ coated film forming process: NdF₃ concentration 1 g/10 mL translucent sol-like solution

(1) A 15-mL NdF₃ coated film formation processing liquid was added to 100 g of magnetic particles having an average particle diameter of 70 to 150 μm for a rare earth magnet, and they were mixed until it was confirmed that the magnetic particles for the rare earth magnet were got wet entirely.
(2) The magnetic particles for rare earth magnet undergone the NdF₃ coated film formation processing of (1) was subjected to the solvent methanol removal under a reduced pressure of 2 to 5 Torr.
(3) The magnetic particles for rare earth magnet undergone the solvent removal of (2) was placed in a quartz boat and subjected to a heat treatment under reduced pressure of 1×10⁻⁵ Torr at 200 degrees C. for 30 minutes and at 400 degrees C. for 30 minutes.
(4) The magnetic particles for rare earth magnet undergone the heat treatment in (3) were examined for magnetic properties.

The film formed as described above was examined by XRD. As a result, it was found that the fluorine compound film is comprised of NdF₃, NdF₂, NdOF or the like.

The powder having a particle diameter of 70 to 150 μm is heated at a temperature of 500 to less than 1100 degrees C. while preventing oxidation to form a high-resistance layer on the surface. When the particle diameter is less than 1 μm, oxidation occurs easily and the magnetic properties are deteriorated readily. When it is larger than 300 μm, the provision of high resistance or another effect that is a magnetic property improving effect by formation of the fluorine compound lowers.

For the magnetic properties, the magnetic particles are placed into a metal mold, temporarily molded in a magnetic field under a compressive load of 2 t/cm², and further sintered in the metal mold at a temperature of 500 degrees C. to less than 1100 degrees C. without exposing to the atmosphere. As a result, the molded product has a residual magnetic flux density of 1.0 T to 1.4 T, and a high-resistance magnet having specific resistance of 0.2 to 2 mΩcm is obtained.

The squareness of a demagnetization curve of the molded product depends on magnetic particle orientation conditions, sintering conditions, and fluorine compound forming conditions. The inclination of the demagnetization curve of the molded product near the zero magnetic field depends on a dispersion degree in the direction of the above c axis and the structure and composition near the interface between the fluorine compound and the magnetic particles. In a molded product having a density of 90 to 99%, the above-described fluorine compound layer is united and diffused, and has grain growth during molding, and partly sintered with the fluorine compound layer on the magnetic particle surfaces served as a binder within the molded product.

When the fluorine compound film has a thickness of about 500 nm, the fluorine compound has a particle diameter of 1 to 30 nm immediately after the fluorine compound is formed on the magnetic particles, but the fluorine compound has a particle diameter of 10 to 500 nm within the molded product, the fluorine compound layer formed on different magnetic particle surfaces is bonded, and there are observed many portions in which the crystal grains have grown and are sintered.

It was found that the fluorine compound crystal in which crystal grains have grown contains iron therein. Since the iron is not present in the fluorine compound before the crystal grains are grown, it is considered that the iron was diffused from the magnetic particles at the time of growth of the crystal grains. It is possible to presume that when the iron is diffused, the rare earth element and also oxygen, which is originally on the magnetic particle surfaces, are also diffused.

The fluorine compound in which the iron has diffused has NdF₂ larger than NdF₃. The concentration of iron in the fluorine compound determined by EDX analysis is 1% to 50% in average. The composition with the concentration of around 50% was amorphous. Since oxygen is also contained, it was found that the molded product has NdF₂, NdF₃, Nd (O, F) and NdFeFO amorphous other than NdFeB magnetic particles mainly having Nd₂Fe₁₄B mother phase, and the fluorine compound and the fluorine-oxygen compound contain therein an average iron concentration of 1% to 50%. It is not known accurately in which site the iron atom is arranged within the fluorine compound or the fluorine-oxygen compound, but it is presumed that the iron atom is relocated to the position of the fluorine or rare earth atom.

Both the above-described high residual magnetic flux density and high resistance can be achieved by forming a fluorine compound layer on R—Fe—X (R denotes a rare earth element, X denotes a third element) or a R-T compound (R denotes a rare earth element, T denotes Fe, Co or Ni), growing the crystal grains in the fluorine compound layer to perform a diffusion reaction with the mother phase, and determining that the fluorine compound layer becomes a sintering binder.

Such a fluorine compound is RFn (n denotes 1 to 3) comprised of fluorine and element R configured of one element or more selected from a rare earth element or Li, Mg, Ca, 3d transition elements and contains 1 to 50% of iron of magnetic particles by hot forming. When the iron concentration in the fluorine compound becomes higher than 50% and in a range of 50 to 80%, the fluorine compound layer becomes amorphous partly, and there is a possibility of deteriorating the magnetic properties. Therefore, it is necessary to select hot molding conditions and fluorine compound forming conditions to have the iron concentration of 50% or below.

For various NdFeB-based magnetic powders, an NdF₃ film or an NdF₂ film was formed on the magnetic particle surfaces, hot-formed samples having a density of 95 to 98% were evaluated for a loss at a frequency of 1 kHz, and the loss was divided to eddy current loss and hysteresis loss by analysis. FIG. 4 shows a relationship between recoil permeability and specific resistance, and a relationship between recoil permeability and individual losses. The horizontal axis represents the recoil permeability, and the vertical axis represents the specific resistance, eddy current loss, hysteresis loss, and a total loss of the eddy current loss and the hysteresis loss.

It is seen from FIG. 4 that when the recoil permeability increases, the specific resistance also increases. But, the total loss of the eddy current loss and the hysteresis loss does not decrease even if the specific resistance is large when the recoil permeability increases. It is seen from the experimental results that the recoil permeability capable of decreasing the loss most is in a range of 1.04 to 1.30, and if it exceeds 1.30, the loss becomes larger than NdFeB molded product. When the fluorine compound is increased its thickness to increase a specific resistance, and heated for molding at a high temperature of 800 degrees C. or more, the Fe is diffused, the soft magnetic component increases, and the recoil permeability increases. It leads to the increase of the hysteresis loss, and the whole loss increases. To prevent the recoil permeability from increasing, it is necessary to prevent 50% or more of Fe from diffusing into the fluorine compound.

Therefore, to obtain a low loss, it is desirable that low-temperature forming is performed even in a forming temperature range of 500 to 800 degrees C., the fluorine compound is determined to have a thickness of 300 nm or below to prevent Fe from diffusing into the fluorine compound layer.

### Example 6

A case that an NdFeB-based sintered magnet surface is undergone pickling or the like to remove oxides, and then NdF₃ is formed on the sintered magnet surface is described below.

As a raw material for the processing liquid, Nd(CH₃COO)₃ is dissolved in H₂O, and HF is added. The addition of HF forms gelatinous NdF₃.XH₂O. The product is subjected to centrifugal separation to remove the solvent, and it is coated on the NdFeB sintered body. The solvent is evaporated from the coated film, and hydrated water is evaporated by heating. The formed film was examined by XRD. As a result, it was found that the fluorine compound film is comprised of the fluorine compound such as NdF₃, NdF₂, NdOF or the like and the oxygen-fluorine compound.

The sintered body is heated at a temperature from 350 to less than 700 degrees C. while preventing oxidation to form a high-resistance layer on the surface. A magnet having the high-resistance layer formed on the surface is laminated, so that eddy current loss due to exposure of the magnet to a high-frequency magnetic field can be reduced.

Since the above-described fluorine compound layer generates heat by millimeter-wave irradiation, to adhere the sintered magnet on which the fluorine compound layer is formed, it is possible that the fluorine compound layer only is selectively heated and adhered by irradiation of millimeter wave. Therefore, heating of the center portion of the sintered body is suppressed, and a reaction proceeds between the rare earth element or the mother phase composing element and the fluorine compound in the fluorine compound.

By the millimeter-wave irradiation, iron atom is diffused to be 1% in average in the fluorine compound layer, the fluorine compound can be adhered by selective heating, and the surface of a sliced magnet having a magnet thickness of 0.1 to 10 mm is selectively heated after the high-resistance layer containing the fluorine compound is formed. Thus, it becomes possible to produce a low-loss sintered magnet.

A processable fluorine compound is mainly comprised of RFn (n denotes 1 to 3, R denotes the above-described element) containing at least one element among alkali element, alkaline earth element and rare earth element and is a nitrogen compound or a boron compound containing at least rare earth element, carbide or halogen element compound.

After the treatment, the above-described fluorine-oxygen compound and fluorine compound containing Fe is grown by millimeter-wave irradiation or microwave irradiation. The above technique can be applied to the sintered magnets having various sizes and shapes, and in order to improve the magnetic properties of the sintered magnet including the layer degraded by fabrication, a phase containing a large amount of fluorine around the magnetic body surface or the grain boundary can be heated selectively by using millimeter wave, the grain boundary diffusion can be enhanced while suppressing the diffusion in the grains, it is effective on the improvement of magnetic properties by diffusing the fluorine or rare earth element to the grain boundary within the magnetic body, and it is effective on a magnet having a thickness of 1 mm to 100 mm.

### Example 7

As an NdFeB-based powder, quenched powder mainly comprised of Nd₂Fe₁₄B is prepared, and a fluorine compound is formed on the powder surface. And, the fluorine compound is also formed on the surface of Fe-based soft magnetic powder. NdFeB-based magnetic particles and Fe-based magnetic particles are temporarily formed separately, at least two temporary molded products are hot formed at the same time, a molded product containing a soft magnetic body and a hard magnetic body can be produced, and it becomes possible to produce parts for low-loss magnetic circuits.

In a case where NdF₃ is formed as a high-resistance film on the quenched powder surface, Nd(CH₃COO)₃ is dissolved as a raw material in H₂O, and HF is added. The addition of HF forms gelatinous NdF₃.XH₂O. The product is subjected to centrifugal separation to remove the solvent, and it is mixed with the above-described NdFeB powder. The solvent is evaporated from the mixture, and hydrated water is evaporated by heating. Similarly, it is mixed with Fe-based magnetic particles and coated.

The formed film was observed by XRD to find that the fluorine compound film is comprised of NdF₃, NdF₂ or NdOF, and NdFeB and Fe-based magnetic particles have high magnetic particle resistance up to around 800 degrees C. because of such a phase.

The NdFeB-based magnetic particles on which the fluorine compound layer is formed expresses anisotropy by deforming at 500 to 750 degrees C. to improve the magnetic properties. And, the Fe-based magnetic particles on which the fluorine compound layer is formed and which exhibit a soft magnetic property can also be formed in the above-described temperature range, and a hysteresis loss can be reduced by distortion removal heat treatment after forming, and high resistance can be maintained, so that an eddy current loss can also be reduced. Forming at 500 to 750 degrees C. can keep the magnetic properties at a density of 90 to 99% because both the NdFeB magnetic particles and the Fe-based magnetic particles on which the fluorine compound is formed can be press formed while holding the high resistance and the magnetic properties at that temperature range.

In this case, there is the fluorine compound between the NdFeB-based magnetic particles and the Fe powder, and the fluorine compound is deformed, diffused, and bonded to form the molded product. A difference in thermal expansion coefficient can be reduced because the fluorine compound is used, and simultaneous forming can be made because it is different from an anisotropy additional process using a magnetic field. Depending on a part shape, it is also possible to form the NdFeB-based magnet in advance, the Fe-based magnetic particles are formed at about room temperature, and distortion removal heat treatment is performed last.

### Example 8

A Ta base layer having a thickness of 10 nm or more was formed on a glass substrate by a sputtering process, and an NdFeB-based thick film having a thickness of 10 to 100 μm was produced.

To form DyF₃, Dy(CH₃COO)₃ is dissolved as a raw material in H₂O, the HF-added gelatinous DyF₃.XH₂O is subjected to centrifugal separation and coated onto the thick film surface. Then, the solvent is removed, and hydrated water is evaporated by heating to grow DyF₃ or DyF₂ on the NdFeB thick film surface. The fluorine compound has a thickness of 1 to 100 nm.

Then, millimeter wave or microwave is irradiated to the fluorine compound film to heat the fluorine compound, and Dy and F atoms are diffused from the surface of the NdFeB film. For the substrate, SiO₂-based glass which is not heated easily by the above-described millimeter wave or microwave may be used.

When Dy and F are diffused, Fe and Nd are also diffused at the same time, 1 at % of Fe becomes visible in the fluorine compound, and the magnetic coercive force and squareness of NdFeB are improved. A thick film magnet having a residual magnetic flux density of 0.7 to 1.1 T and a magnetic coercive force of 10 to 20 kOe is obtained.

### Example 9

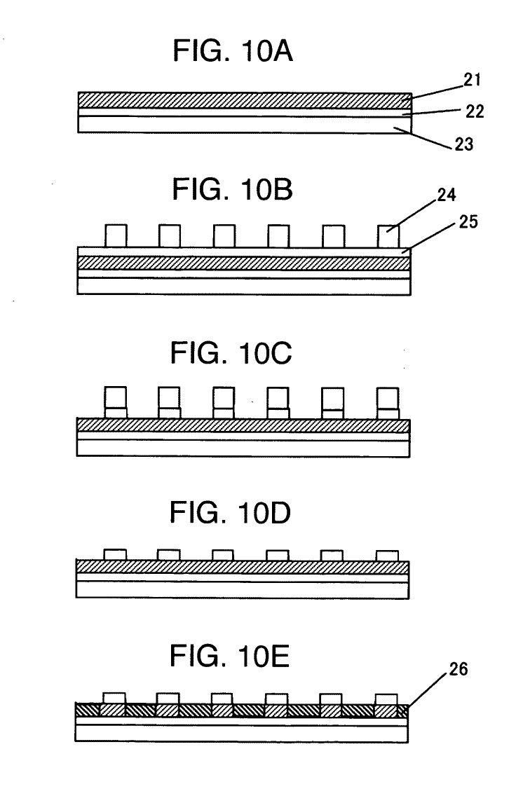

In FIGS. 10A to 10E, a Ta base 22 is formed 1 to 100 nm on an SiO₂-based substrate 23 by sputtering, and an NdFeB film 21 is formed 10 to 1000 nm on the base. A gelatinous solution DyF₃.XH₂O containing centrifugally separated iron ion is coated thereon in uniform film thickness (1 to 1000 nm) by a spinner. A resist 24 is coated on a fluorine compound layer 25, and after exposure and development, the resist 24 remains along a mask which is used like FIG. 10B. Then, the fluorine compound layer 25 whose portions not covered with the resist are removed by milling or the like to have the structure as shown in FIG. 10C, and the resist is removed with an organic solvent or the like to configure the film as shown in FIG. 10D. In this state, a millimeter-wave heating processing is performed. For the millimeter-wave heating, a 28-GHz millimeter-wave heating apparatus manufactured by FUJIDENPA KOGYO CO., LTD. is used to selectively heat only the fluorine compound. This heating causes diffusion between the fluorine compound and the NdFeB film to grow a reaction layer 26, and the magnetic properties of the NdFeB are changed. The reaction layer 26 may be only the interface with the fluorine compound layer 25.

The change in magnetic properties is variable depending on the type of the fluorine compound used. When the fluorine compound such as DyF₃ or TbF₃ is used, the improvement of magnetic coercive force of the NdFeB film near the contact portion or a change in magnetic properties such as thermal demagnetization suppression can be confirmed.

Thus, only the portion of the NdFeB film in contact with the fluorine compound can be changed to improve the magnetic properties. Its area is changed according to the size of a resist pattern and can comply with a fine pattern of submicron to a large pattern. For not only the NdFeB magnetic film but also the Fe-based magnetic film such as FePt, FeSiB, NiFe or a Co-based magnetic film such as CoFe, CoPt, the magnetic properties of only the contact portion can be changed.

Since the millimeter wave is used, only the vicinity of the fluorine compound can be heated while suppressing the heating of the substrate, and an ordinary heat treatment time can be reduced by forming the fluorine compound film on the entire magnetic film and irradiating the millimeter wave, and it is also possible to perform a heat treatment capable of regularizing without a base. Such a technique can be used for local heating of not only a magnetic recording medium but also in a magnetic head process.

Similar to the above, a Ta base layer having a thickness of 10 nm or more was formed on a glass substrate by a sputtering process, and an NdFeB-based thick film having a thickness of 10 to 100 μm was produced. To form DyF₃, Dy(CH₃COO)₃ is dissolved as a raw material in H₂O, and the HF-added gelatinous NdF₃.XH₂O is subjected to centrifugal separation and coated onto the thick film surface. Then, the solvent is removed, hydrated water is evaporated by heating, and DyF₃ or DyF₂ grows on the NdFeB thick film surface. The fluorine compound has a thickness of 1 to 100 nm. For the fluorine compound layer, the sputtering process or a vapor deposition method may be used.

Then, millimeter wave or microwave is irradiated to the fluorine compound film to heat the fluorine compound, and Dy and F atoms are diffused from the surface of the NdFeB film. For the substrate, SiO₂-based glass which is not heated easily by the above-described millimeter wave or microwave may be used.

When Dy and F are diffused, Fe and Nd are also diffused at the same time, 1 at % of Fe becomes visible in the fluorine compound, and the magnetic coercive force and squareness of NdFeB are improved. A thick film magnet having a residual magnetic flux density of 0.7 to 1.1 T and a magnetic coercive force of 10 to 20 kOe is obtained.

### Example 10

A process of forming a rare earth-fluorine compound or an alkaline-earth metal fluorine compound coated film on a soft magnetic plate was performed as follows.

(1) Processing liquid for forming a neodymium fluorine compound film was produced as follows.

First, salt containing Dy which is highly soluble into water is mixed with water and dissolved by stirring. Diluted hydrofluoric acid was added gradually. A solution in which a gel-like precipitated fluorine compound was produced was further stirred and subjected to centrifugal separation. Then, methanol was added to the resultant product. The methanol solution was further stirred, and the methanol solution in which a corrosive ion was diluted was prepared as a processing liquid.

(2) NdF₃ coated film formation processing liquid was dripped and mixed until it was confirmed that the soft magnetic plate got wet.
(3) NdF₃ coated film formation treatment soft magnetic plate was subjected to the removal of the solvent methanol under reduced pressure of 2 to 5 Torr.
(4) the solvent-removed soft magnetic plate was subjected to a heat treatment under reduced pressure of 1×10⁻⁵ Torr at 200 degrees C. for 30 minutes and 40 degrees C. for 30 minutes.

The soft magnetic plate is an iron-based or Co, Ni-based ferromagnetic material such as a sheet-like amorphous material or an electromagnetic stainless steel plate.

A fluorine compound is formed on such a soft magnetic plate, which is then heated by the millimeter wave, so that only a portion which is contacted to the fluorine compound can be heated. And, the fluorine compound layer is partly formed, so that the portion on which the fluorine compound is formed is locally heated by millimeter-wave irradiation. Mechanical strength is held by a non-heated portion by partly heating to reduce hysteresis of the amorphous material, and both strength and loss can be achieved by reducing a loss of the heating portion. And, only a fluorine compound-coated portion of the electromagnetic stainless steel is heated by millimeter wave to enable to change from ferromagnetic to nonmagnetic or from nonmagnetic to ferromagnetic of only the heating portion, and it can be applied to a rotating machine using a reluctance torque.

### Example 11

A gel- or sol-like rare earth-fluorine compound is coated onto the surface of an NdFeB-based sintered magnet. The coated rare earth-fluorine compound has an average film thickness of 10 to 10000 nm. The NdFeB-based sintered magnet is a sintered magnet having Nd₂Fe₁₄B as the main phase, and the surface of the sintered magnet has a deteriorated magnetic properties because of fabrication polishing.

To improve the magnetic property degradation, the gel- or sol-like rare earth-fluorine compound is coated and dried on the sintered magnet surface, and a heat treatment is performed at a temperature of 500 degrees C. or more and a sintering temperature or below. Immediately after coating and drying, the gel- or sol-like rare earth-fluorine compound particles grow to particles of 100 nm or less and 1 nm or more, and further heating causes a reaction with the grain boundary and surface of the sintered magnet and diffusion.

To coat the gel- or sol-like rare earth-fluorine compound onto the sintered magnet surface, the fluorine compound is formed on substantially the entire surface of the sintered magnet surface along the shapes of the crystal grains of the surface. After coating and drying and before heating at a temperature of 500 degrees C. or more, the portion having a high rare earth element concentration is partially fluorinated on the crystal grain surface which is a part of the sintered magnet surface.

Among the above-described rare earth-fluorine compounds, the Dy fluorine compound or the Tb, Ho fluorine compound has the configuring elements Dy, Tb, Ho diffused along the crystal grain boundary, and the magnetic property degradation is improved. When the heat treatment temperature becomes 800 degrees C. or more, the mutual diffusion of the fluorine compound and the sintered magnet proceeds furthermore, Fe in concentration of 10 ppm or more is observed in the fluorine compound layer. As the heat treatment temperature becomes higher, the Fe concentration in the fluorine compound layer tends to increase, and when the Fe concentration exceeds 50%, the magnetic properties of the sintered magnet are degraded. Therefore, the Fe concentration of the fluorine compound is desirably 50% or below.

To laminate and adhere the sintered magnet, a fluorine compound which becomes another adhesive layer different from the fluorine compound that the magnetic properties is improved by diffusing is coated after the above-described heat treatment, laminated, and only the vicinity of the adhesive layer is heated by performing the millimeter-wave irradiation, thereby enabling to adhere the sintered magnet. The fluorine compound which is the adhesive layer is an Nd fluorine compound (NdF₂₋₃, Nd(OF)₁₋₃), only the vicinity of the adhesive layer can be heated selectively while suppressing the temperature of the center portion of the sintered magnet from increasing by selecting the millimeter-wave irradiation conditions, and the magnetic property degradation and the size change of the sintered magnet involved in the adhesion can be suppressed. And, the use of the millimeter wave enables to reduce a heat treatment time of the selective heating to a half or below of the conventional heat treatment time and is suitable for mass-production.

Therefore, the millimeter wave can be used for not only the adhesion of the sintered magnet but also the improvement of the magnetic properties by diffusion of the coating material. It is possible to diffuse by heating without using the millimeter wave, but the use of the millimeter wave can heat the fluorine compound portion selectively and can adhere the magnetic material and various types of metallic materials and oxide materials.

As another example of the present invention, in a case where a surface magnet rotor has a sintered magnet arranged on the surface, the fluorine compound is coated onto the magnet surface of the surface magnet rotor, and the millimeter wave is irradiated, so that the magnetic properties on the surface side can be improved, and the magnetic coercive force of an easily demagnetizable portion can be improved. It is not necessary to coat onto the entire surface of the magnet, and the coated amount of the fluorine compound is small, so that the cost can be reduced.

An example of millimeter-wave conditions includes 28 GHz, 1 to 10 kW, and 1 to 30 minute irradiation in an Ar atmosphere. The millimeter wave can be used to selectively heat a fluorine compound, an oxygen-fluorine compound containing oxygen, or a rare earth oxide, so that the texture of the sintered body itself is not changed substantially but only the fluorine compound can be diffused along the grain boundary, diffusion of the fluorine compound-composing elements into the crystal grains can be prevented, and high magnetic properties (any of high residual magnetic flux density, squareness improvement, high magnetic coercive force, high Curie temperature, low thermal demagnetization, high corrosion resistance, and provision of high resistance) can be obtained in comparison with a case of simply heating. By selection of the millimeter-wave conditions and the fluorine compound, the fluorine compound-composing elements can be diffused into a portion deeper from the surface of the sintered magnet than by an ordinary heat treatment, and it is possible to diffuse into the center portion of a 10×10×10 cm magnet.

The magnetic properties of the sintered magnet obtained by the above technique include a residual magnetic flux density of 1.0 to 1.6 T and a magnetic coercive force of 20 to 50 kOe, and the concentration of the heavy rare earth element contained in the rare earth sintered magnet having the same magnetic properties can be made lower than a case of using the conventional heavy rare earth added NdFeB-based magnetic particles.

If the sintered magnet surface has 1 to 100 nm of the fluorine compound or the oxygen-fluorine compound containing at least one of alkali, alkaline earth or rare earth element remaining on it, the sintered magnet surface has a high resistance, the eddy current loss is reduced even if laminated and adhered, and a loss in the high-frequency magnetic field can be reduced. Since heat generation of the magnet can be reduced by the loss reduction, the used amount of the heavy rare earth elements can be reduced.

Since the above-described rare earth-fluorine compound is not powdery, it can be coated into vary small holes of 1 nm to 100 nm and can be applied to the improvement of the magnetic properties of very fine magnet parts. Instead of the fluorine compound, at least one kind of compound with a light element, such as nitrogen compound, carbon compound or boron compound containing at least one kind of rare earth element is formed on at least one sintered NdFeB-based block surface, and millimeter wave is irradiated. Thus, bonding of the block and the magnetic properties improving effect can be confirmed similar to the fluorine compound.

### Example 12

One atom % or more of Fe is added to a gel- or sol-like fluorine compound to produce an Fe ion or Fe cluster mixed gel- or sol-like Fe-fluorine compound. At this time, Fe atoms are partly bonded chemically with any one or more elements among alkali, alkaline earth, Cr, Mn, V or rare earth elements configuring the fluorine compound or the fluorine of the fluorine compound.

A millimeter wave or microwave is irradiated to such a gel- or sol-like fluorine compound or fluorine compound precursor to increase the number of atoms contributing to chemical bonding of fluorine atoms and Fe atoms and one or more of the above-described fluorine compound composing elements, a ternary or more fluorine compound composed of Fe fluorine and one or more of the above-described fluorine compound composing elements is formed, and a fluorine compound having a magnetic coercive force of 10 kOe or more can be synthesized by irradiation of millimeter wave. Another transition metal element ion may be added as a part or a substitute of Fe ion. A magnet material can be obtained by the above technique without a dissolving and pulverizing process for obtaining the magnetic powder of the prior art, and it can be applied to various magnetic circuits.

When it is assumed that alkali, alkaline earth, Cr, Mn, V or rare earth element configuring the above-described fluorine compound is M, an Fe-M-F-based, Co-M-F-based or Ni-M-F-based magnet can be applied to magnet parts having shapes which are hardly machined because a high magnetic coercive force magnet can be obtained by using a gel-like, sol-like, or liquefied fluorine compound and can be produced by coating on various substrates which are hardly dissolvable by millimeter-wave irradiation and irradiating millimeter wave. Mixture of atoms such as oxygen, carbon, nitrogen, boron and the like into such a fluorine compound magnet does not have many effects on the magnetic properties.

### Example 13

A gel- or sol-like fluorine compound is coated onto the surfaces of SmFeN-based magnetic particles having a particle diameter of 0.1 to 100 μm. The fluorine compound is a compound containing at least one of alkali, alkaline earth or rare earth element. A sol or gel of the fluorine compound or fluorine compound precursor is coated to a thickness of 1 to 10000 nm, the coated SmFeN-based magnetic particles are placed into a metal mold, and compression molded in a magnetic field of 3 to 20 kOe while orientating the magnetic particles in the direction of the magnetic field to produce a temporary molded product.

A temporary molded product having anisotropy is heated by millimeter-wave irradiation to selectively heat the fluorine compound. Magnetic property degradation involved in a structural change of the SmFeN-based magnetic particles while heating is suppressed, the fluorine compound serves as a binder, the anisotropic magnet can be produced, and a magnet which has the SmFeN magnetic particles bound by the fluorine compound can be obtained. A volume occupied by the fluorine compound is determined to be 0.1 to 3%, and an SmFeN anisotropic magnet having a residual magnetic flux density of 1.0 T or more can be obtained. After the temporary molded product is formed, it is impregnated with a fluorine compound liquid and subjected to a heat treatment. Thus, the magnetic properties can also be improved.

Sm—Fe—N—F or Sm—Fe—N—O is locally formed, but it is confirmed that its reaction with the fluorine compound provides any effect among an increase of magnetic coercive force, improvement of squareness, and an increase of residual magnetic flux density. In a case of nitrogen-based magnetic particles such as SmFeN-based magnetic particles, SmFeN-based magnetic particles are produced by millimeter-wave irradiation to SmFe powder, the increase of the magnetic coercive force by nitridation is considerable in comparison with the conventional ammonia nitridation or the like, and a magnetic coercive force of 20 kOe or more can be obtained.

Binding by the fluorine compound using millimeter wave can also be applied to other iron-based materials such as Fe—Si-based, Fe—C-based, FeNi-based, FeCo-based, Fe—Si—B-based or Co-based magnetic material, and can also be applied to soft magnetic powder, soft magnetic ribbon, soft magnetic molded product, hard magnetic powder, hard magnetic ribbon and hard magnetic molded product without deteriorating the magnetic properties, and other metal-based materials can also be adhered.

### Example 14

Fine particles containing 1 atom % or more of Fe having a particle diameter of 1 to 100 nm are added to a gel- or sol-like fluorine compound to produce a gel- or sol-like Fe-fluorine compound which is mixed with the Fe-based fine particles. At this time, Fe atoms of the surfaces of fine particles are partly bonded chemically with any one or more of alkali, alkaline earth or rare earth elements configuring the fluorine compound or fluorine of the fluorine compound.

Millimeter wave or microwave is irradiated to a gel- or sol-like fluorine compound or fluorine compound precursor containing the above fine particles to increase the atoms contributing to the chemical bonding of fluorine atoms and one or more of Fe atoms and the above-described fluorine compound-composing elements, ternary or more fluorine compounds comprised of Fe fluorine and one or more of the above-described fluorine compound-composing elements are formed, and a fluorine compound having a magnetic coercive force of 10 kOe or more can be synthesized by millimeter-wave or microwave irradiation. Other transition metal element fine particles may be added instead of the Fe-based fine particles. A magnet material can be obtained by the above technique without a dissolving and pulverizing process for obtaining the magnetic powder of the prior art, and it can be applied to various magnetic circuits.

When it is assumed that alkali, alkaline earth or rare earth element configuring the above-described fluorine compound is M, Fe-M-F-based, Co-M-F-based or Ni-M-F-based magnet can be applied to magnet parts having shapes which are hardly machined because a high magnetic coercive force magnet can be obtained by using the technique of adding fine particles to gel-like, sol-like or liquefied fluorine compound, and can be produced by coating on various substrates and irradiating millimeter-waves.

Mixture of atoms such as oxygen, carbon, nitrogen, and the like into such a fluorine compound magnet does not have many effects on the magnetic properties. The above-described gel- or sol-like fluorine compound is inserted into a shape patterned using a resist or the like, dried, and subjected to a heat treatment at a heat resistant temperature or below of the resist. By additional heating after the resist is removed, a magnetic coercive force is increased. The above-described sol-like or gel-like fluorine compound can be injected or coated into a space having a resist interval of 10 nm or more, and a magnet portion thickness of 1 nm or more, and a small magnet can be produced without machining a three dimensionally shaped magnet and without using a physical technique such as vapor deposition, sputtering or the like.

### Example 15

Particles containing at least one or more rare earth elements having a particle diameter of 10 to 10000 nm are added to a gel- or sol-like fluorine compound. Particles having an Nd₂Fe₁₄B structure as a main phase are used as an example of particles, and the gel- or sol-like fluorine compound is coated on the surfaces of the particles.

Using a mixing ratio of gel- or sol-like fluorine compound and particles or a coating condition as a parameter, a coverage factor of the surfaces of particles can be changed. When the coverage factor is 1 to 10%, a magnetic coercive force increasing effect by the fluorine compound can be confirmed, when it is 10 to 50%, the improvement of squareness of a demagnetization curve or improvement of Hk is observed in addition to the magnetic coercive force-increasing effect, and when the coverage factor is 50 to 100%, a resistance increase after molding can be confirmed. Here, the coverage factor means an area covered with the material coated on the surface area of particles.

A sintered magnet can be obtained by hot forming at a temperature of 800 degrees C. or more after temporarily forming in a magnetic field using particles having a coverage factor of 1 to 10%. A covering gel-like or sol-like fluorine compound is a fluorine compound containing at least one or more rare earth element. The gel- or sol-like fluorine compound can be coated into a layer form along the interface of particles even if the particles have irregularity because a liquefied gel- or sol-like fluorine compound is used. When the particles have a coverage factor of 1 to 10%, a rare earth element which is a part of a layer-like fluorine compound is diffused along the crystal grain boundary by a heat treatment after the temporary forming in a magnetic field, and a magnetic coercive force is increased in comparison with a case without a coat.

When the gel- or sol-like fluorine compound is coated on Fe-based particles, the surfaces of particles not having the coating material are partly fluorinated. Therefore, when the particles have a coverage factor of 1 to 10%, even if an area of a portion where the fluorine compound is formed is 1 to 10%, 90% of the surfaces of particles depends on the composition of particles and the surface condition but fluorinated, the magnetic properties of the interface is changed, and the resistance of the surfaces of particles is increased.

Since the rare earth element is fluorinated readily, when the particles have a higher rare earth concentration on the surfaces of particles, the surfaces of particles are partly fluorinated when coated with the gel- or sol-like fluorine compound, and the resistance of the surfaces of particles becomes high. When such high-resistance particles are sintered, the rare earth element in the particles are bonded with fluorine of the surfaces of particles to have a structure that the rare earth element is segregated near the grain boundary, and the magnetic coercive force is increased. Namely, fluorine exercises a trapping effect of rare earth atoms and suppresses diffusion of rare earth elements in the grains, so that the rare earth element segregates on the grain boundary, the magnetic coercive force increases, and the rare earth element concentration in the grains is lowered, and a high residual magnetic flux density can be obtained.

### Example 16

Particles containing at least one rare earth element having a particle diameter of 10 to 10000 nm are added to a gel- or sol-like fluorine compound solution. As a particle example, particles or minute magnets which have an Nd₂Fe₁₄B structure as a main phase are used, a gel- or sol-like fluorine compound is contacted to the surfaces of particles, and the fluorine compound coating solution adhered to the surfaces of particles is removed by a solvent or the like. It is made not to leave the gel- or sol-like fluorine compound as much as possible on the surfaces of particles, and a residual volume of the coating material is determined to be an average coverage factor of 10% or below. Therefore, an average of 90% or more of the area of particles becomes a surface (clear fluorine compound coated is not observed through an electron scanning microscope of 10000 magnifications) where the coating material is not formed, but the surface partly has the rare earth element configuring the particles partly fluorinated and becomes a layer rich in fluorine.

Thus, the surfaces of particles is partly fluorinated because the rare earth element is easily bonded with the fluorine atom, and if there is no rare earth element, the surface is not easily fluorinated. In a case where the rare earth element is partly fluorinated, the rare earth element is also easily bonded with the oxygen atom to become an oxygen-fluorine compound, but a phase comprised of rare earth elements bonded with fluorine is formed on the surfaces of particles.

The fluorinated particles were used to produce an anisotropic sintered magnet by compression molding in a magnetic field and then sintering. After the compression molding in the magnetic field, the temporary molded product having a density in a range of 50 to 90% was impregnated with the above-described fluorine compound solution. The surfaces of particles and the surfaces of cracked portions of particles can also be partly coated with a fluorine compound precursor. By the above impregnation processing, 1 to 100 nm of the fluorine compound can be coated including the cracked portions partly, contributing to any of the effects such as an increase of magnetic coercive force, improvement of squareness, provision of high resistance, a decrease of residual magnetic flux density, the reduction of used amount of rare earth, improvement of strength, addition of anisotropy of magnetic particles and the like. At the time of sintering, fluorine and rare earth elements are diffused. In comparison with the case of not performing fluorination, as the added amount of heavy rare earth element is larger, an increase of magnetic coercive force by the fluorination becomes prominent. Concentration of the heavy rare earth element necessary to obtain the sintered magnet having the same magnetic coercive force can be reduced by the fluorination. It is presumed that the magnetic coercive force becomes high because there is produced a structure that the heavy rare earth element is segregated in the vicinity of the grain boundary because the heavy rare earth element becomes easy to segregates in the vicinity of the fluorinated phase by fluorination. A segregation width of the heavy rare earth element is about 1 to 100 nm from the grain boundary.

### Example 17

A fluorine compound solution is coated on oxide particles having a particle diameter of 10 to 10000 nm containing at least one rare earth element, and heating is made at a temperature in a range of 800 to 1200 degrees C. or by millimeter-wave irradiation. An oxygen-fluorine compound is partly formed by heating.

A solution containing at least one rare earth element is used as a fluorine compound solution to form an oxygen-fluorine compound or a fluorine compound, thereby improving the magnetic properties of an oxide barium ferrite or strontium ferrite particles. Thus, the improvement of a magnetic coercive force, squareness of a demagnetization curve and a residual magnetic flux density can be confirmed.

Especially, when a fluorine compound solution containing 1% or more of iron is used, an effect of increasing the residual magnetic flux density is great. Oxide particles of the above-described oxygen-fluorine compound may be produced by using a sol-gel process.

### Example 18

One atom % or more of Co or Ni is added to a gel- or sol-like fluorine compound solution to produce a gel- or sol-like Co or Ni-fluorine compound solution mixed with Co, Ni ion or Co, Ni cluster. At this time, Co or Ni atoms are partly bonded chemically with any one or more elements of alkali, alkaline earth, or rare earth elements configuring the fluorine compound or fluorine of the fluorine compound.

The above gel- or sol-like fluorine compound or fluorine compound precursor is dried by irradiation of millimeter wave or microwave to increase the number of atoms contributing to chemical bonding of the fluorine atom with the Co or Ni atom and one or more of the above-described fluorine compound composing elements, a ternary or more fluorine compound composed of Co or Ni fluorine and one or more of the above-described fluorine compound composing elements is formed, and a fluorine compound having a magnetic coercive force of 10 kOe or more can be synthesized by irradiation of millimeter wave. Another transition metal element ion may be added as a part or a substitute of Co or Ni ion. A magnet material can be obtained by the above technique without the dissolving and pulverizing process for obtaining the magnetic powder as in the prior art, and it can be applied to various magnetic circuits.

When it is assumed that alkali, alkaline earth or rare earth element configuring the above-described fluorine compound is M, a Co-M-F-based, Co-M-F-based or Ni-M-F-based magnet can be applied to magnet parts having shapes which are hardly machined because a high magnetic coercive force magnet or magnet powder can be obtained by using a gel-like, sol-like or liquefied fluorine compound and can be produced by coating on various substrates which are hardly dissolved by millimeter-wave irradiation and irradiating millimeter wave. Mixture of atoms such as oxygen, carbon, nitrogen, and the like into such a fluorine compound magnet does not have many effects on the magnetic properties.

### Example 19

Fine particles containing 1 atom % or more of Fe having a particle diameter of 1 to 100 nm are added to a gel- or sol-like fluorine compound to produce a gel- or sol-like Fe-fluorine compound which is mixed with Fe-based fine particles. At this time, Fe atoms of the surfaces of fine particles are partly bonded chemically with any one or more elements of alkali, alkaline earth, or rare earth element composing the fluorine compound or fluorine of the fluorine compound.

When millimeter wave or microwave is irradiated to a gel- or sol-like fluorine compound or a fluorine compound precursor which contains fine particles or cluster described above, the number of atoms contributing to chemical bonding of fluorine atom and Fe atom and one or more of the above-described fluorine compound composing elements increases. Mutual magnetization of the Fe atoms partially becomes ferromagnetic by any of bonding of Fe atom and rare earth element via fluorine atoms, bonding of fluorine atom and oxygen atom with Fe and rare earth element, or bonding of rare earth element with fluorine atom, oxygen atom and Fe atom.

Magnetization of Fe atoms in part takes antiferromagnetic coupling. Millimeter-wave or microwave irradiation produces a structure advantageous for the ferromagnetic coupling, and the fluorine compound containing Fe having a magnetic coercive force of 10 kOe or more can be synthesized. Another transition metal element fine particles may be added instead of the Fe-based fine particles.

Namely, for transition metal elements such as Cr, Mn, V and the like other than Co and Ni, a permanent magnet material can be obtained by the above technique without a dissolving and pulverizing process for obtaining the magnetic powder as in the prior art, and it can be applied to various magnetic circuits. The obtained magnetic body has a resistance higher than 1 mΩcm, and the resistance is variable in a range of 1% to 10% depending on the magnitude and direction of the applied magnetic field. Accordingly, the magnetized state can be checked by measuring electrical resistance.

### Example 20

Fine particles containing 1 atom % or more of Fe having a particle diameter of 1 to 100 nm are added to a gel- or sol-like fluorine compound solution to produce a gel- or sol-like Fe-fluorine compound mixed with Fe-based fine particles. At this time, Fe atoms of the surfaces of fine particles are partly bonded chemically with any one or more elements of alkali, alkaline earth or rare earth element composing the fluorine compound or fluorine of the fluorine compound.

When millimeter wave or microwave is irradiated to a gel- or sol-like fluorine compound or a fluorine compound precursor which contains the fine particles or cluster described above, the number of atoms contributing to chemical bonding of fluorine atom and Fe atom and one or more of the above-described fluorine compound composing elements increases. Mutual magnetization of the Fe atoms partially becomes ferromagnetic and has magnetic anisotropy by any of bonding of Fe atom and rare earth element via fluorine atoms, bonding of fluorine atom and oxygen atom with Fe and rare earth element, or bonding of rare earth element with fluorine atom, oxygen atom and Fe atom.

In the fine particles, a phase (10 to 50% of fluorine) having fluorine in a large amount, a phase (50 to 85% of Fe) having Fe in a large amount and a phase (20 to 75% of rare earth element) having rare earth elements in a large amount are formed, so that the phase having Fe in a large amount serves to magnetize, the phase having fluorine in a large amount or the phase having a rare earth element in a large amount contributes to high magnetic coercive force. Magnetization of Fe atoms in part takes antiferromagnetic coupling. Millimeter-wave or microwave irradiation produces a structure advantageous for the ferromagnetic coupling, and a fluorine compound having a magnetic coercive force of 10 kOe or more can be synthesized. Another transition metal element fine particles may be added instead of the Fe-based fine particles.

A permanent magnet material of the self-starting permanent magnet synchronous motor can be obtained by the above technique without a dissolving and pulverizing process for obtaining the magnetic powder as in the prior art.

### Example 21

A gel- or sol-like rare earth-fluorine compound is coated on the surface of NdFeB-based sintered magnet having Nd₂Fe₁₄B as a main phase. The coated rare earth-fluorine compound has an average film thickness of 1 to 10000 nm. An NdFeB-based sintered magnet is a sintered magnet which has a crystal particle diameter of 1 to 20 μm in average, and Nd₂Fe₁₄B as a main phase, and the surface of the sintered magnet is observed having degradation of magnetic properties involved in fabrication or polishing on the demagnetization curve.

For the improvement of the magnetic property degradation, the increase of magnetic coercive force by rare earth element segregation in the vicinity of the grain boundary, the improvement of squareness of the demagnetization curve, the provision of high resistance on the magnet surface or in the vicinity of grain boundary, the provision of high Curie point by the fluorine compound, the provision of high strength, the provision of high corrosion resistance, the reduction of used amount of rare earth, the reduction of the magnetized magnetic field and the like, the gel- or sol-like rare earth-fluorine compound solution is coated and dried on the sintered magnet surface, and subjected to a heat treatment at a temperature of 500 degrees C. or more and a sintering temperature or below.

Immediately after coating and drying, the gel- or sol-like rare earth-fluorine compound particles grow to particles of 100 nm or less and 1 nm or more, and further heating causes a reaction with the grain boundary and surface of the sintered magnet and diffusion. The fluorine compound particles through coating and drying have not undergone the pulverizing process, so that the particles do not have a surface with projections or acute angles. When the particles are observed through a transmission electron microscope, they have a rounded shape similar to an oval shape or a round shape, and no crack is observed. The particles are united to grow on the sintered magnet surface by heating and, at the same time, cause diffusion along the grain boundary of the sintered magnet or mutual diffusion with the composing elements of the sintered magnet.

To coat the gel- or sol-like rare earth-fluorine compound onto the sintered magnet surface, the fluorine compound is formed on substantially the entire surface of the sintered magnet. After coating and drying and before heating at a temperature of 500 degrees C. or more and a sintering temperature or below, a portion having a high rare earth element concentration is partially fluorinated on the crystal grain surface which is a part of the sintered magnet surface.

The fluorinated phase and the fluorinated phase containing oxygen grow while partly keeping a consistency with the mother phase. The fluorine compound phase or the oxygen-fluorine compound phase grows consistently outside when viewed from the mother phase of the fluorinated phase or the oxygen-fluorinated phase, and a heavy rare earth element segregates on the fluorinated phase, the fluorine compound phase or the oxygen-fluorine compound phase to increase a magnetic coercive force.

A strip portion where the heavy rare earth element is condensed along the grain boundary desirably has a width in a range of 1 to 100 nm, and in this range, the high residual magnetic flux density and the high magnetic coercive force can be satisfied. When Dy is condensed along the grain boundary by the above-described technique, the magnetic properties of the obtained sintered magnet include a residual flux density of 1.0 to 1.6 T and a magnetic coercive force of 20 to 50 kOe, and a heavy rare earth element concentration contained in the rare earth sintered magnet having the same magnetic properties can be lowered to a level lower than the case that the conventional heavy rare earth added NdFeB-based magnetic particles are used. Fe concentration in the fluorine compound of the sintered magnet surface described above is variable depending on the heat treatment temperature, and when heated at 1000 degrees C. or more, 10 ppm or more and 5% or less of Fe is diffused into the fluorine compound. The Fe concentration becomes 50% in the vicinity of the grain boundary of the fluorine compound, but when the average concentration is 1% to 5%, it does not have much influence on the magnetic properties of the sintered magnet as a whole.

### Example 22

Fine particles containing 1 atom % or more of Fe having a particle diameter of 1 to 100 nm are added to a gel- or sol-like fluorine compound solution to produce a gel- or sol-like Fe-fluorine compound with which Fe-based fine particles are mixed. At this time, Fe atoms of fine particle surfaces are partly bonded chemically with any one or more elements among the alkali, alkaline earth or rare earth element configuring the fluorine compound or fluorine of the fluorine compound.

When millimeter wave or microwave is irradiated to a gel- or sol-like fluorine compound or a fluorine compound precursor which contain the fine particles or cluster described above in a nitrogen-containing atmosphere, the number of atoms contributing to chemical bonding of fluorine atom or nitrogen atom and Fe atom and one or more of the above-described fluorine compound composing elements increases. Mutual magnetization of the Fe atoms partially becomes ferromagnetic to have magnetic anisotropy by any of bonding of Fe atom and rare earth element via fluorine atom and nitrogen atom, bonding of fluorine atom and oxygen atom with Fe and rare earth element, or bonding of rare earth element with fluorine atom, oxygen atom, nitrogen atom and Fe atom.

In the fine particles, a phase (10 to 50% of fluorine) having fluorine in a large amount, a phase (3 to 20% of nitrogen) having nitrogen in a large amount, a phase (50 to 85% of Fe) having Fe in a large amount and a phase (10 to 75% of rare earth element) having rare earth elements in a large amount are formed, so that the phase having Fe in a large amount serves to magnetize, and a phase having fluorine or nitrogen in a large amount or a phase having a rare earth element in a large amount contributes to high magnetic coercive force.

Such an Fe-M-F-N quaternary magnet (M denotes a rare earth element, alkali, or alkaline earth element) which has magnetic properties of a magnetic coercive force of 10 kOe or more is obtained.

### Example 23

Fine particles containing 1 atom % or more of Fe having a particle diameter of 1 to 100 nm are added to a gel- or sol-like fluorine compound solution to produce a gel- or sol-like Fe-fluorine compound with which Fe—B fine particles are mixed. If the fine particles have a diameter exceeding 100 nm, the original characteristic of the soft magnetic component Fe remains therein through the later process, and when its diameter becomes smaller than 1 nm, the oxygen concentration to the Fe becomes high, and it becomes hard to improve the magnetic properties. Therefore, the particle diameter is desirably 1 to 100 nm.

At this time, Fe atoms of the Fe—B fine particle surfaces are partly bonded chemically with any one or more elements among the alkali, alkaline earth or rare earth element configuring the fluorine compound or fluorine of the fluorine compound.

When millimeter wave or microwave is irradiated to a gel- or sol-like Fe—B containing fluorine compound or fluorine compound precursor which contains fine particles or cluster described above, the number of atoms contributing to chemical bonding of fluorine atom or boron (B) atom and Fe atom and one or more of the above-described fluorine compound composing elements increases. Mutual magnetization of the Fe atoms partially becomes ferromagnetic to have magnetic anisotropy by any of bonding of Fe atom and rare earth element via fluorine atom, bonding of fluorine atom and boron atom and Fe and rare earth element, or bonding of rare earth element with fluorine atom, oxygen atom, boron atom and Fe atom.

In the fine particles, a phase (10 to 50% of fluorine) having fluorine in a large amount, a phase (5 to 20% of boron) having boron in a large amount, a phase (50 to 85% of Fe) having Fe in a large amount and a phase (10 to 75% of rare earth element) having rare earth elements in a large amount are formed, so that the phase having Fe in a large amount serves to magnetize, and a phase having fluorine or boron in a large amount or a phase having a rare earth element in a large amount contributes to high magnetic coercive force.

Such a Fe-M-B-F quaternary magnet (M denotes a rare earth element, alkali or alkaline earth element) which has a magnetic properties of a magnetic coercive force of 10 kOe or more is obtained, and when the M is determined to be a heavy rare earth element, the Curie temperature can be set to 400 to 600 degrees C.

### Example 24

A sol- or gel-like precursor which is growable to a rare earth-fluorine compound is coated on the surface of NdFeB-based sintered magnet having Nd₂Fe₁₄B as a main phase at a temperature of 100 degrees C. or more. The coated rare earth-fluorine compound precursor has an average film thickness of 1 to 10000 nm. An NdFeB-based sintered magnet is a sintered magnet which has a crystal particle diameter of 1 to 20 μm in average, and Nd₂Fe₁₄B as a main phase, and the surface of the sintered magnet is observed having degradation of magnetic properties involved in fabrication or polishing on the demagnetization curve.

For the improvement of the magnetic properties degradation, the increase of magnetic coercive force by rare earth element segregation in the vicinity of the grain boundary, the improvement of squareness of the demagnetization curve, the provision of high resistance in the vicinity of the magnet surface or grain boundary, the provision of high Curie point by the fluorine compound, the provision of high strength, provision of high corrosion resistance, the reduction of used amount of rare earth, reduction of the magnetized magnetic field and the like, the gel- or sol-like rare earth-fluorine compound precursor is coated and dried on the sintered magnet surface, and subjected to a heat treatment at a temperature of 500 degrees C. or more and a sintering temperature or below.

The gel- or sol-like rare earth-fluorine compound precursor grows to particles of 100 nm or below to 1 nm or more in coating and drying processes, and additional heating causes a reaction of the precursor or the fluorine compound cluster in part with the grain boundary and surface of the sintered magnet and diffusion.

The fluorine compound particles through coating, drying and heating have not undergone the pulverizing process in a temperature range that the particles are not united mutually, so that they doe not have a surface with projections or acute angles. When the particles are observed through a transmission electron microscope, they have a rounded shape similar to an oval shape or a round shape, and no crack is observed within the particles or the surfaces of particles, and no discontinuous irregularities is observed on the contour.

The particles are united to grow on the sintered magnet surface by heating and, at the same time, causes mutual diffusion with the diffusion or sintered magnet composing elements along the grain boundary of the sintered magnet. To coat such a gel- or sol-like rare earth-fluorine compound precursor on the surface of the sintered magnet, the fluorine compound precursor is coated and dried on substantially the entire surface of the sintered magnet, a portion having a high rare earth element concentration on the surfaces of crystal grains on a part of the sintered magnet surface is partially fluorinated. The fluorinated phase or the fluorinated phase containing oxygen grows while partly keeping a consistency with the mother phase. The fluorine compound phase or the oxygen-fluorine compound phase grows consistently outside when viewed from the mother phase of the fluorinated phase or the oxygen-fluorinated phase, and a heavy rare earth element segregates on the fluorinated phase, the fluorine compound phase or the oxygen-fluorine compound phase to increase a magnetic coercive force. A strip portion where the heavy rare earth element is condensed along the grain boundary desirably has a width in a range of 0.1 to 100 nm, and in this range, the high residual magnetic flux density and the high magnetic coercive force can be satisfied.

When Dy is condensed along the grain boundary using a DyF₂₋₃ precursor by the above-described technique, the magnetic properties of the obtained sintered magnet include a residual flux density of 1.0 to 1.6 T and a magnetic coercive force of 20 to 50 kOe, and a heavy rare earth element concentration contained in the rare earth sintered magnet having the same magnetic properties can be lowered to a level lower than the case that the conventional heavy rare earth added NdFeB-based magnetic particles are used.

Fe concentration in the fluorine compound of the sintered magnet surface described above is variable depending on the heat treatment temperature, and when heated at 1000 degrees C. or more, 10 ppm or more and 5% or less of Fe is diffused into the fluorine compound. The Fe concentration becomes 50% in the vicinity of the grain boundary of the fluorine compound, but when the average concentration is 5% or less, it does not have much influence on the magnetic properties of the sintered magnet as a whole.

### Example 25

SmCo alloy is dissolved by high frequency dissolving or the like and pulverized in inert gas. The pulverized powder diameter is 1 to 10 μm. A fluorine compound precursor (SmF₃ precursor) is coated and dried on the surface of the pulverized powder, and the coating powder is oriented by a magnetic field press machine to produce a green compact. Lots of cracks are introduced into the powder of the green compact, a fluorine compound precursor is coated and dried from the outside of the green compact, so that the cracked surface is also partly coated with the fluorine compound precursor. The resultant product is sintered and quenched. The sintered body is comprised of at least two phases, namely SmCo₅ and Sm₂Co₁₇ phases. The fluorine compound starts decomposing at the time of sintering and distributed on both the two phases, but a larger number of fluorine atoms are present on the SmCo₅ phase, and a coercive field strength is increased in comparison with the case that no fluorine compound precursor is added. And, as a fluorine compound precursor coating effect, any of the provision of high resistance, the improvement of squareness and the improvement of demagnetization resistance could be confirmed.

### Example 26

Particles which have the vicinity of Nd₂Fe₁₄B composition as a main phase and a particle diameter of 1 to 20 μm are used, and a temporary molded product undergone magnetic field pressing is heated in inert gas or in vacuum at a temperature range of 500 degrees C. to 1000 degrees C. and impregnated or coated with a fluorine compound precursor solution.

By the above process, the fluorine compound precursor solution enters along the interface of magnetic particles in the molded product, and the interface is partly coated with the fluorine compound precursor. The impregnated or coated molded product is sintered at a temperature higher than the above heating temperature, and undergone a heat treatment at a temperature lower than the sintering temperature in order to improve a magnetic coercive force to obtain a sintered body containing a rare earth element, alkali or alkaline earth element which is a fluorine and precursor composing element.

This process has features that a rare earth rich phase is formed on the surfaces of magnetic particles partly or entirely before sintering, a gap of 1 nm or more is secured excepting the contact portions between the magnetic particles and the magnetic particles without sintering completely, the fluorine compound precursor is entered and coated in the gap by impregnating or coating, and the fluorine compound precursor is coated partly on the surfaces of magnetic particles in the molded product other than the outermost surface of the molded product.

By this process, the fluorine compound precursor can be coated on the surfaces of magnetic particles at the center portion of a 100 mm sintered body, and the heavy rare earth element is segregated in the vicinity of the crystal grain boundary of the sintered body by selecting a heavy rare earth element such as Dy, Tb for the fluorine compound precursor composing element. Therefore, it is possible to perform any of the increase of the magnetic coercive force, the improvement of the squareness, the increase of the residual magnetic flux density, the decrease of the magnetic coercive force temperature coefficient or the temperature coefficient of the residual magnetic flux density, and the decrease of degradation in magnetic properties due to alteration by fabrication.

The segregation of the heavy rare earth element described above is 1 to 100 nm from the crystal grain boundary, varies depending on the heat treatment temperature, and has a tendency of spreading at a unique point such as the grain boundary triple junction.

### Example 27

In a case where an NdFeB-based sintered magnet having the Nd₂Fe₁₄B structure as a main phase is subjected to fabrication polishing and adhered to the laminated electromagnetic steel plate to produce a rotor, a magnet insertion position of the laminated electromagnetic steel plate is previously fabricated by a metal mold or the like. To insert the sintered magnet into the magnet insertion position, a gap of 0.01 to 0.5 mm is formed between the sintered magnet and the laminated electromagnetic steel plate.

Various sintered magnets including a curved shape such as a rectangular shape, a ring shape or a barrel roof shape are inserted into the magnet position including the gap, a gel- or sol-like fluorine compound solution is injected into the gap, and heated at a temperature of 100 degrees C. or more to adhere the sintered magnet and the laminated electromagnetic steel plate.

At this time, the rare earth element or fluorine is diffused to the sintered magnet surface by further conducting a heat treatment at a temperature of 500 degrees C. or more to diffuse the fluorine compound composing elements to the surface of the laminated electromagnetic steel plate or green compact iron. Thus, the magnetic properties of the sintered magnet are improved (such as the increase of the magnetic coercive force, the improvement of the squareness, the improvement of the demagnetization resistance, the increase of the Curie temperature), and the adhesion can be strengthened.

The magnetic properties of a work affected layer of the curved portion of the sintered magnet can be improved, and the diffused layer which is mainly composed of fluorine or rare earth element at the surface and grain boundary of the each magnetic material may contain light elements such as oxygen and carbon. For the improvement of the magnetic properties of the sintered magnet, the rare earth element is contained in the above-described fluorine compound, but for an adhesion effect, soft magnetic distortion removal or loss reduction other than the improvement of the magnetic properties, the fluorine compound containing the rare earth element or alkali, alkaline earth element can be used.

### <Effects of Self-Starting Permanent Magnet Synchronous Motor Applying the Above Permanent Magnet>

### Example 28

The features of the permanent magnet described above in detail are summarized and enable to increase the magnetic coercive force, improve the squareness, improve the demagnetization resistance, improve the magnetizability, increase the Curie temperature and provide high resistance without degrading the residual magnetic flux density.

When the permanent magnet is applied to the self-starting permanent magnet synchronous motor, lowering of the residual magnetic flux density does not occur. Therefore, the characteristics at normal time can be maintained and the magnet can be provided with high resistance, so that an eddy-current loss generated on the magnet is decreased. In addition, since the holding force is improved, the residual magnetic flux density at the operation point of the magnet can be increased, capable of contributing to the improvement of the characteristics.

And, the substantial improvement of the demagnetization resistance of the magnet can suppress the generation of the demagnetization of magnet due to an excessive reverse magnetic field at the time of activation, producing a large effect of improving the reliability.

In addition, since magnetizability is excellent, a desired magnetization amount can be secured by magnetizing the windings even if the outer circumference portion of the rotor has a conductive starting conductor.

### <Another Example of Self-Starting Permanent Magnet Synchronous Motor>

### Example 29

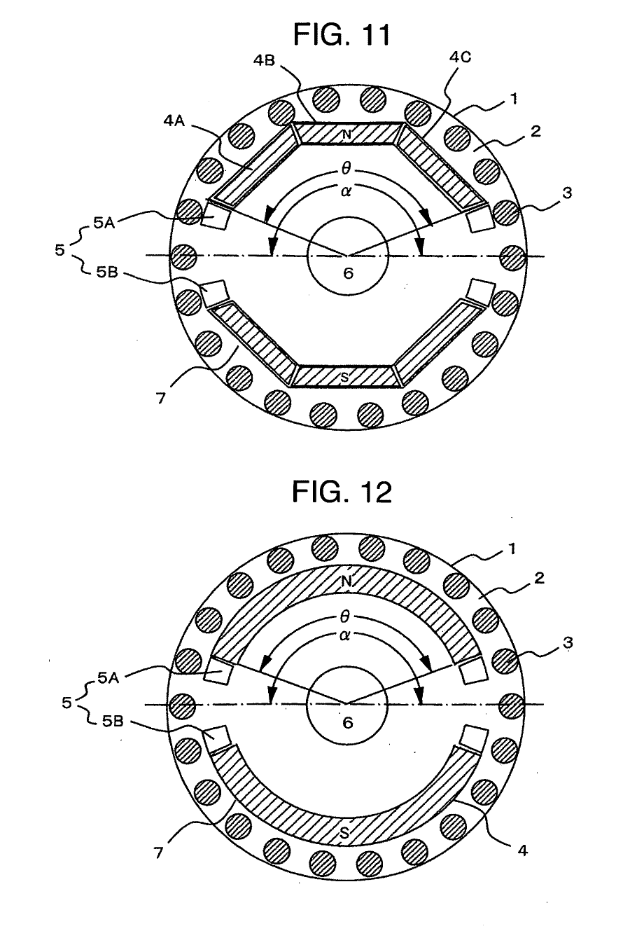

FIG. 11 is a rotor radial cross-sectional view of a synchronous motor according to another example of the present invention. In FIG. 11, like component parts corresponding to those of FIG. 1, FIG. 2 are denoted by like reference numerals, and overlapped descriptions will be omitted.

This structure is different from that of FIG. 1, FIG. 2 on the point that permanent magnets 4A, 4B, 4C are configured to have a substantially trapezoidal shape. By configuring in this way, the same characteristics as in FIG. 1 can be obtained.

This figure shows three segments, but it is needless to say that the same effects can be obtained by dividing into a larger number of segments.

### Example 30

FIG. 12 is a rotor radial cross-sectional view of a synchronous motor according to another example of the present invention. In FIG. 12, like component parts corresponding to those of FIG. 1, FIG. 2, FIG. 11 are denoted by like reference numerals, and overlapped descriptions will be omitted.

This structure is different from those of FIG. 1, FIG. 2, FIG. 11 on the point that the permanent magnet 4 is configured to have a substantially arc shape.

A permanent magnet production process according to the present invention can also be applied to such an arc shape. And, when configured to have the arc shape, the same characteristics as those of FIG. 1 can be obtained and, there are advantages that a larger flux amount of the magnet can be used, and the motor characteristics can be further improved.

### Example 31

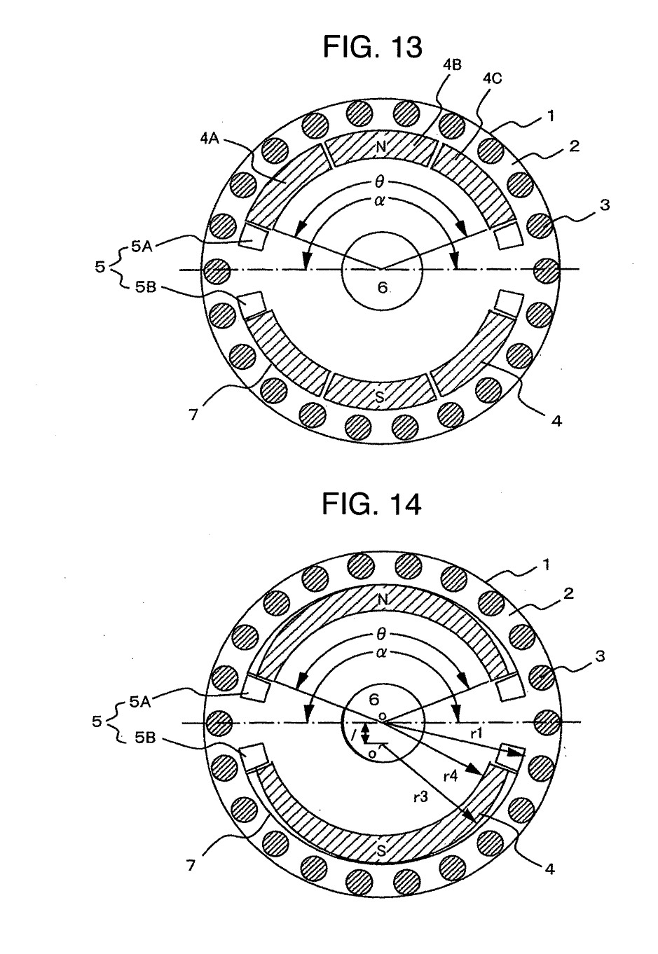

FIG. 13 is a rotor radial cross-sectional view of a synchronous motor according to another example of the present invention. In FIG. 13, like component parts corresponding to those of FIG. 12 are denoted by like reference numerals, and overlapped descriptions will be omitted.

This structure is different from that of FIG. 12 on the point that the permanent magnet 4 is configured by separately arranging as three permanent magnets 4A, 4B, 4C in a circumferential direction at a regular pitch.

By configuring as described above, the same characteristics as those of FIG. 12 can be obtained, and the rotor strength can be improved.

FIG. 13 shows the three segments, but it is needless to say that the same effect can be obtained by dividing into a larger number of segments.

### Example 32

FIG. 14 is a radial cross-sectional view of a rotor of a synchronous motor according to another example of the present invention. In FIG. 14, like component parts corresponding to those of FIG. 12 are denoted by like reference numerals, and overlapped descriptions will be omitted.

In FIG. 14, differences from FIG. 12 are a radius (hereinafter simply referred to as the outer diameter) r3 of an arc forming the outer circumference of the permanent magnet 4 is made short with respect to outer diameter r1 of the magnet insert hole 7, and non-concentric with it. Namely, outer diameter r1 of the magnet insert hole 7 is a arc having a radius r1 with point of origin O of the shaft 6 determined as the center. Meanwhile, outer diameter r3 of the permanent magnet 4 is a arc having a radius r3 with a point O1 displaced from the point of origin O by a distance 1 determined as the center. The inside diameter of the permanent magnet 4 is equal to the inside diameter r4 of the magnet insert hole 7.

When an eccentric magnet is used as in this example, a gap length of an end portion in the circumferential direction of the magnet is increased, so that it becomes possible to make the spatial magnetic flux density distribution of the gap closer to a sine wave. Therefore, this example provides the same effects as those of FIG. 12, contributing to lowering of a harmonic loss due to gap harmonic flux, and lowering of vibration and noise due to a harmonic electromagnetic excitation force.

### Example 33

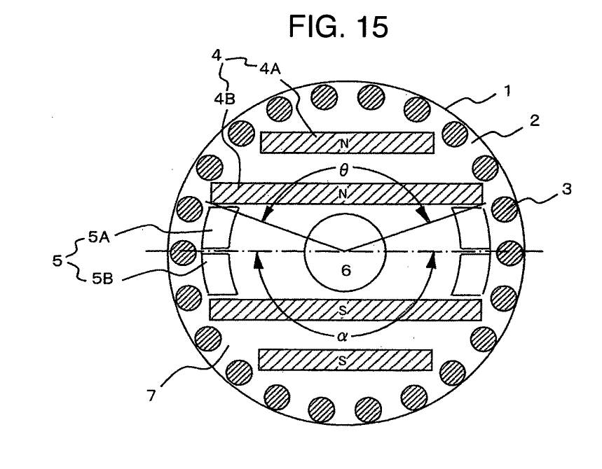

FIG. 15 is a rotor radial cross-sectional view of a synchronous motor according to another example of the present invention.

In FIG. 15, like component parts corresponding to those of FIG. 1, FIG. 2, FIG. 11 to FIG. 14 are denoted by like reference numerals, and overlapped descriptions will be omitted.

In this drawing, the portions different from those of FIG. 1, FIG. 2, FIG. 11 to FIG. 14 have the permanent magnet 4 formed of a flat plate, and one magnetic pole is configured by stacking two flat plates 4A, 4B.

Thus, the same characteristics as those in FIG. 1, FIG. 2, FIG. 11 to FIG. 14 can be obtained. Since a magnetic path area between the overlapped permanent magnets increases, the magnetic resistance in a q axis direction electrically displaced by 90 degrees from the center axis (d axis) of the magnetic pole decreases, so that it is possible to utilize the reluctance torque, and the motor characteristics can be improved furthermore.

The self-starting permanent magnet synchronous motor of the present invention can be expected to be applied to a compressor motor or the like to be driven at a high temperature.

It should be further understood by those skilled in the art that although the foregoing description has been made on embodiments of the invention, the invention is not limited thereto and various changes and modifications may be made without departing from the spirit of the invention and the scope of the appended claims.

1. A self-starting permanent magnet synchronous motor, comprising:
a stator which has a stator iron core and stator windings; and
a rotor which is arranged rotatably with respect to the stator with a gap between them, wherein:
the rotor is provided with a plurality of slots formed in a circumferential direction in a rotor iron core and in the vicinity of an outer circumference portion of the rotor iron core, conductive bars each embedded in the slots, conductive end ring which short-circuits the bars at axial end surfaces, and at least one permanent magnet which is embedded in at least one magnet insert hole arranged on the inner circumference side of the bars;
the permanent magnet configures a field pole;
the permanent magnet has particles composed of a ferromagnetic material having iron as a main component, and a fluorine compound layer formed of fluorine compound particles of one or more of alkali element, alkaline earth element and rare earth element;
the fluorine compound layer is formed into a layer form on the surfaces of particles made of the ferromagnetic material; and
the fluorine compound particles are magnets having an iron concentration of 1 atom % to 50 atom %.

2. The self-starting permanent magnet synchronous motor according to claim 1, wherein the permanent magnet is a magnet that the iron contained in the permanent magnet is contained in the fluorine compound particles without changing a crystal structure of the fluorine compound.

3. The self-starting permanent magnet synchronous motor according to claim 1, wherein the permanent magnet is composed of magnetic particles that the particles made of the ferromagnetic material are comprised of R—Fe—B (R denotes rare earth element).

4. The self-starting permanent magnet synchronous motor according to claim 1, wherein the permanent magnet is a magnet with the fluorine compound particles mainly composed of any of NdF₃, LiF, MgF₂, CaF₂, ScF₃, VF₂, VF₃, CrF₂, CrF₃, MnF₂, MnF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂, and BiF₃.

5. The self-starting permanent magnet synchronous motor according to claim 1, wherein the permanent magnet has the fluorine compound particles determined to have an average particle diameter of from 1 nm to 500 nm, and the fluorine compound layer is formed to have higher resistance than the particles made of the ferromagnetic material.

6. The self-starting permanent magnet synchronous motor according to claim 1, wherein the permanent magnet is a magnet having a recoil permeability of larger than 1.04 and less than 1.30, and a specific resistance of 0.2 mΩcm or more.

7. The self-starting permanent magnet synchronous motor according to claim 1, wherein the permanent magnet is a magnet which has the fluorine compound layer formed with a coverage factor of from 50% to 100% on the surfaces of particles made of the ferromagnetic material.

8. The self-starting permanent magnet synchronous motor according to claim 1, wherein the permanent magnet is a magnet that the fluorine compound particles make grain growth with hot forming of particles made of the ferromagnetic material.

9. The self-starting permanent magnet synchronous motor according to claim 1, wherein the permanent magnet has a grain growth range of the fluorine compound particles that an average crystal grain size of 1 nm to 500 nm.

10. The self-starting permanent magnet synchronous motor according to claim 1, wherein the permanent magnet is a molded product which has a dimensional relationship of thickness<width<axial length, and is formed into a flat shape having a substantially rectangular cross-sectional shape in the thickness direction.

11. The self-starting permanent magnet synchronous motor according to claim 1, wherein the permanent magnet is formed by laminating a plurality of flat shape molded products having a dimensional relationship of thickness<width<axial length and a substantially rectangular cross-sectional shape in the thickness direction.

12. The self-starting permanent magnet synchronous motor according to claim 1, wherein the permanent magnet is a molded product formed into a flat shape which has a dimensional relationship of thickness<width<axial length, and its cross-sectional shape in the thickness direction is a substantially trapezoidal shape.

13. The self-starting permanent magnet synchronous motor according to claim 1, wherein the permanent magnet is the molded product which has its cross-sectional shape in the thickness direction formed into a substantially arc shape.

14. The self-starting permanent magnet synchronous motor according to claim 1, wherein the permanent magnet is the molded product formed nonconcentric with respect to the outer diameter of the magnet insert hole.

15. The self-starting permanent magnet synchronous motor according to claim 1, wherein it is assumed that a circumferential pitch angle is θ and a pole pitch angle is α, then at least one permanent magnet which forms the field pole is embedded in a range that θ/α exceeds 0.54 and 0.91 or below.

16. The self-starting permanent magnet synchronous motor according to claim 1, wherein at least one hole is provided between the magnetic poles of the rotor.

17. A self-starting permanent magnet synchronous motor, comprising:
a stator which has a stator iron core and stator windings; and
a rotor which is arranged rotatably with respect to the stator with a gap between them, wherein:
the rotor is provided with a plurality of slots and at least one permanent magnet embedded in the slots;
the permanent magnet configures a field pole;
the permanent magnet has particles made of a ferromagnetic material having iron as a main component, and a fluorine compound layer formed of fluorine compound particles of one or more of alkali element, alkaline earth element and rare earth element;
the fluorine compound layer is formed into a layer form on the surfaces of particles made of the ferromagnetic material;
the fluorine compound particles are magnets having an iron concentration of 1 atom % to 50 atom %; and
the permanent magnet is a magnet with the fluorine compound particles mainly composed of any of NdF₃, LiF, MgF₂, CaF₂, ScF₃, VF₂, VF₃, CrF₂, CrF₃, MnF₂, MnF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂ and BiF₃.

18. The self-starting permanent magnet synchronous motor according to claim 17, wherein the permanent magnet is a magnet which has a dimensional relationship of thickness<width<axial length, and the fluorine compound layer is formed with a coverage factor of 50% to 100% on the surfaces of particles made of the ferromagnetic material.

19. The self-starting permanent magnet synchronous motor according to claim 18, wherein it is assumed that a circumferential pitch angle is θ and a pole pitch angle is α, then at least one permanent magnet which forms the field pole is embedded in a range that θ/α exceeds 0.54 and 0.91 or below.
